(19) United States
(12) Patent Application Publication
(10) Pub. No.: US 2026/0266981 A1
(43) Pub. Date: Sep. 10, 2026

(54) METHOD AND APPARATUS FOR SENSING CONTROL AND SENSING PERFORMING IN ULTRA WIDEBAND WIRELESS NETWORK SYSTEM

(71) Applicant: LG ELECTRONICS INC., Seoul (KR)

(72) Inventors: Jeonghwan YOON, Seoul (KR); Jinsoo CHOI, Seoul (KR); Hongwon LEE, Seoul (KR); Hangyu CHO, Seoul (KR); Insun JANG, Seoul (KR)

(73) Assignee: LG ELECTRONICS INC., Seoul (KR)

(21) Appl. No.: 19/166,377

(22) PCT Filed: Mar. 22, 2024
(86) PCT No.: PCT/KR2024/003600

§ 371 Date: Sep. 17, 2025

(30) Foreign Application Priority Data
Mar. 22, 2023 (KR) 10-2023-0037529

(51) Int. Cl. G01S 13/76; G01S 13/02

(52) U.S. Cl. CPC G01S 13/765; G01S 13/0209

(57) ABSTRACT

Disclosed are a method and apparatus for sensing control and sensing performing in an ultra wideband wireless network system. The method performed by a first device in an ultra wideband (UWB) wireless network system, according to an embodiment of the present disclosure, may comprise the steps of: in a sensing control phase, transmitting control information comprising one or more of first information and second information to a second device, the first information indicating a sensing role of the second device and the second information indicating a sensing mode in a sensing phase; and in the sensing phase, performing transmission or reception of a sensing packet on the basis of the control information.

### CROSS-REFERENCE TO RELATED APPLICATIONS

This application is the National Stage filing under 35 U.S.C. 371 of International Application No. PCT/KR2024/003600, filed on Mar. 22, 2024, which claims the benefit of earlier filing date and right of priority to Korean Application No. 10-2023-0037529, filed on Mar. 22, 2023, the contents of which are all hereby incorporated by reference herein in their entireties.

### TECHNICAL FIELD

The present disclosure relates to a sensing control and sensing performance method and device in an ultra-wideband wireless network system.

### BACKGROUND

A low-rate (LR) wireless networks may support low data rate connectivity between fixed or mobile devices having limited battery consumption requirements. For example, a LR wireless network may be applied to a wireless personal area network (WPAN). The Institute of Electrical and Electronics Engineers (IEEE) 802.15.4 standard defines various technologies for a physical layer (PHY) and a medium access control (MAC) sublayer for a LR wireless network. For example, the IEEE 802.15.4 standard defines various modes that support precise ranging.

An ultra wideband (UWB) wireless network may support transmitting massive information at low power over a very wide band (e.g., a frequency band of 3.1 GHZ-10.6 GHz). For example, an UWB technology may support transmitting digital sign information wirelessly by converting it into an impulse signal with a very short time duration below a nanosecond. The IEEE 802.15.4z standard defines an ultra wideband (UWB) technology related to the ranging technology. For example, the IEEE 802.15.4z standard includes a high-rate pulse frequency (HRP) PHY technology that supports high-speed data communication (e.g., 27-31 Mbps) and accurate two-way ranging and positioning, and a high-rate pulse frequency (LRP) PHY technology that supports various modes for low-speed data communication (e.g., a Radio Frequency Identification (RFID) application). Furthermore, the IEEE 802.15.4z standard includes an UWB PHY technology that refines the integrity and accuracy of ranging measurement, and a MAC technology that supports the exchange of ranging-related information between devices participating in ranging and the control of a time-of-flight (TOF) ranging procedure. Recently, the IEEE 802.15.4ab standard for the advancement of an UWB PHY/MAC including the refinement of the IEEE 802.15.4z standard-based wireless network technology is under discussion.

### SUMMARY

A technical problem of the present disclosure is to provide a method and a device for transmitting or receiving control information on a sensing mode, a sensing role, etc. between devices in an UWB wireless network system.

An additional technical problem of the present disclosure is to provide a method and a device for performing sensing signal transmission/reception, sensing report reception/transmission, etc. based on sensing control information transmitted or received between devices in an UWB wireless network system.

The technical objects to be achieved by the present disclosure are not limited to the above-described technical objects, and other technical objects which are not described herein will be clearly understood by those skilled in the pertinent art from the following description.

A method performed by a first device in an ultra wideband (UWB) wireless network system according to an aspect of the present disclosure may include transmitting control information including at least one of first information or second information to a second device in a sensing control phase, wherein the first information indicates a sensing role of the second device and the second information indicates a sensing mode in a sensing phase; and performing transmission or reception of a sensing packet based on the control information in the sensing phase.

A method performed by a second device in an ultra wideband (UWB) wireless network system according to an additional aspect of the present disclosure may include receiving control information including at least one of first information or second information from a first device in a sensing control phase, wherein the first information indicates a sensing role of the second device and the second information indicates a sensing mode in a sensing phase; and performing transmission or reception of a sensing packet based on the control information in the sensing phase.

According to the present disclosure, a method and a device for transmitting or receiving control information on a sensing mode, a sensing role, etc. between devices in an UWB wireless network system may be provided.

According to the present disclosure, a method and a device for performing sensing signal transmission/reception, sensing report reception/transmission, etc. based on sensing control information transmitted or received between devices in an UWB wireless network system may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a block configuration diagram of a wireless communication device according to an embodiment of the present disclosure.

FIG. 2 is a diagram for describing a HRP UWB PPDU format to which the present disclosure may be applied.

FIG. 3 is a diagram representing a RMARKER position according to a STS packet configuration in a HRP-ERDEV PPDU format to which the present disclosure may be applied.

FIG. 4 is a diagram for describing two-way ranging techniques to which the present disclosure may be applied.

FIG. 5 is a diagram for describing examples of a format of a RMI IE, a RCPCS IE, a RRMC IE and a RRTI IE to which the present disclosure may be applied.

FIG. 6 shows an example of a message sequence chart for SS-TWR applying a deferred reply time result to which the present disclosure may be applied.

FIG. 7 shows an example of a message sequence chart for SS-TWR applying an embedded reply time result to which the present disclosure may be applied.

FIG. 8 shows an example of a message sequence chart for SS-TWR using a SP3 packet to which the present disclosure may be applied.

FIG. 9 shows an example of a message sequence chart for DS-TWR to which deferred reply time information to which the present disclosure may be applied is applied.

FIG. 10 shows an example of a message sequence chart for DS-TWR to which embedded ranging time information to which the present disclosure may be applied is applied.

FIG. 11 is a diagram for describing the role of a device in a ranging procedure to which the present disclosure may be applied.

FIG. 12 shows examples of ARC IE, RDM IE, RBU IE, RR IE and SRRE IE formats to which the present disclosure may be applied.

FIG. 13 is a diagram for describing a ranging block structure and a ranging phase to which the present disclosure may be applied.

FIG. 14 shows examples of a timing diagram for various multi-device ranging to which the present disclosure may be applied.

FIG. 15 shows a timing diagram in an example of a block-based mode to which the present disclosure may be applied.

FIG. 16 is a diagram for describing examples of various transmission offsets to which the present disclosure may be applied.

FIG. 17 shows an example of a message sequence chart for one-to-many SS-TWR to which the present disclosure may be applied.

FIG. 18 shows an example of a message sequence chart for SP3 one-to-many SS-TWR to which the present disclosure may be applied.

FIG. 19 is a diagram representing an example of a MMS packet to which the present disclosure may be applied.

FIG. 20 is a diagram representing additional examples of a MMS packet to which the present disclosure may be applied.

FIG. 21 is a diagram representing additional examples of a MMS packet to which the present disclosure may be applied.

FIG. 22 is a diagram for describing the operation of the first device according to the present disclosure.

FIG. 23 is a diagram for describing the operation of the second device according to the present disclosure.

FIG. 24 is a diagram for describing a sensing block structure and a sensing phase according to the present disclosure.

FIG. 25 represents an example of an information element (IE) including sensing-related control information according to the present disclosure.

FIG. 26 is a diagram representing an example of active sensing and passive sensing according to the present disclosure.

FIG. 27 is a diagram for describing an example of the operation of devices in a mono-static sensing mode according to the present disclosure.

FIG. 28 is a diagram for describing examples of the operation of devices in a multi-static sensing mode according to the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The examples of the present disclosure may be applied to various wireless communication systems. For example, the examples of the present disclosure may be applied to an IEEE 802.15 standard-based wireless network (e.g., Zigbee, Bluetooth, etc.). In particular, the examples of the present disclosure may be applied to an IEEE 802.15.4 standard-based wireless network, and further, may be applied to a newly proposed IEEE 802.15.4ab standard-based UWB wireless network, or a next-generation UWB wireless network after IEEE 802.15.4ab. A wireless communication system to which the examples of the present disclosure are applied is not limited to a wireless network of the IEEE 802.15 series, and may be applied to a wireless local area network (WLAN) technology or a Wi-Fi technology of the IEEE 802.11 series, and may be applied to a cellular wireless communication system (e.g., a technology of the Long Term Evolution (LTE) series of the 3rd Generation Partnership Project (3GPP) standard and a 5G New Radio (NR)).

The IEEE 802.15.4ab standard including a technology for further advancing an UWB PHY/MAC is under discussion. For example, in the IEEE 802.15.4ab standard, additional coding, a preamble and a modulation technique for supporting improved link budget and/or reduced air-time; an additional channel and operating frequency; an interference reduction technology to support higher device density and higher traffic use cases; improvement of accuracy, precision, reliability and interoperability for high-integrity ranging; a technique for reducing complexity and power consumption; definition of a hybrid operation with narrowband signaling to support an UWB; refined native discovery and connection setup mechanism; a sensing capability for supporting presence detection and environment mapping; a mechanism supporting high data-rate streaming allowing a minimum throughput of 50 Mbps as well as low-power and low-latency streaming; support for peer-to-peer, peer-to-multi-peer, station-to-infrastructure protocol and infrastructure synchronization mechanism, etc. are discussed.

Hereinafter, technical features to which examples of the present disclosure may be applied will be described.

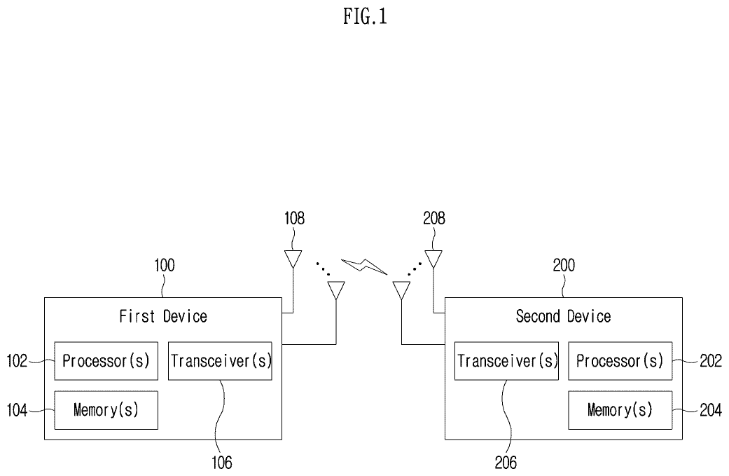

FIG. 1 illustrates a block diagram of a wireless communication device according to an embodiment of the present disclosure.

The first device 100 and the second device 200 illustrated in FIG. 1 may be replaced with various terms such as a terminal, a wireless device, a Wireless Transmit Receive Unit (WTRU), an User Equipment (UE), a Mobile Station (MS), an user terminal (UT), a Mobile Subscriber Station (MSS), a Mobile Subscriber Unit (MSU), a subscriber station (SS), an advanced mobile station (AMS), a wireless terminal (WT), or simply user, etc. In addition, the first device 100 and the second device 200 include an access point (AP), a base station (BS), a fixed station, a Node B, a base transceiver system (BTS), a network, It may be replaced with various terms such as an Artificial Intelligence (AI) system, a road side unit (RSU), a repeater, a router, a relay, and a gateway.

When devices 100 and 200) illustrated in FIG. 1 support ranging, it may be called a ranging-capable device (RDEV) or an enhanced ranging-capable device (ERDEV). For example, devices 100 and 200 illustrated in FIG. 1 may be called various terms such as a transmitting device, a receiving device, a transmitting RDEV, a receiving RDEV, a transmitting ERDEV, a receiving ERDEV, etc. For example, devices 110 and 200 may be called an initiator, a responder, an originator, a recipient, a controller, a controlee, etc. according to a role in a ranging operation. The role of one device is not fixed, but may be relatively determined according to a relationship with other devices. When one device interacts with multiple devices, one device may play multiple roles.

Referring to FIG. 1, the first device 100 and the second device 200 may transmit and receive a wireless signal through various UWB wireless network technologies (e.g., IEEE 802.15.4 series). The first device 100 and the second device 200 may include an interface for a medium access control (MAC) layer and a physical layer (PHY) that follow the regulations of the IEEE 802.15.4 standard. The IEEE 802.15.4-based PHY and MAC are included in an UWB subsystem, and an UWB subsystem may further include an UWB command interface (UCI) corresponding to an interface between an UWB controller and a host. An UWB subsystem may exchange a message with a host system through an UCI.

In addition, the first device 100 and the second device 200 may additionally support various communication standards (e.g., IEEE 802.15 series, IEEE 802.11 series, 3GPP LTE series, 5G NR series standards, etc.) technologies other than UWB wireless network technology. In addition, the device of the present disclosure may be implemented in various devices such as a mobile phone, a vehicle, a personal computer, augmented reality (AR) equipment, and virtual reality (VR) equipment, etc. In addition, the device of the present specification may support various communication services such as a voice call, a video call, data communication, autonomous-driving, machine-type communication (MTC), machine-to-machine (M2M), device-to-device (D2D), IoT (Internet-of-Things), etc.

The first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including instructions for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement an UWB wireless network technology (e.g., IEEE 802.15.4 series). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

The second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including instructions for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement an UWB wireless network technology (e.g., IEEE 802.15.4 series). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, an instruction and/or a set of instructions.

One or more memories 104, 204 may be connected to one or more processors 102, 202 and may store data, a signal, a message, information, a program, a code, an indication and/or an instruction in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

For example, the transceivers 106 and 206 of FIG. 1 may perform a transmission and reception operation of a signal (e.g., a packet or a physical layer protocol data unit (PPDU) conforming to IEEE 802.15.4, etc.). In addition, in the present disclosure, an operation in which various devices generate transmission/reception signals or perform data processing or calculation in advance for transmission/reception signals may be performed by the processors 102 and 202 of FIG. 1. For example, an example of an operation of generating a transmission/reception signal or performing data processing or calculation in advance for the transmission/reception signal may include 1) determining/acquiring/configuring/calculating/decoding/encoding bit information of fields included in the PPDU, 2) determining/configuring/acquiring time resources or frequency resources used for fields included in the PPDU; 3) determining/configuring/acquiring a specific sequence used for fields included in the PPDU action, 4) power control operation and/or power saving operation applied to a device, 5) operations related to ACK signal determination/acquisition/configuration/calculation/decoding/encoding, etc. In addition, in the following example, various information (e.g., information related to fields/subfields/control fields/parameters/power, etc.) used by various devices to determine/acquire/configure/calculate/decode/encode transmission and reception signals may be stored in the memories 104 and 204 of FIG. 1.

In an UWB band, a device may perform medium access based on a Carrier Sense Multiple Access with Collision Avoidance (CSMA/CA) mechanism. A CSMA/CA mechanism may perform Clear Channel Assessment (CCA) that senses a wireless channel or medium for a predetermined time duration before a device starts transmission. Sensing may be performed, for example, by an energy detection (ED) method based on a predetermined threshold. As a result of sensing, if a medium is determined to be in an idle status, transmission is started through a corresponding medium. On the other hand, when a medium is detected to be occupied or busy, a device may attempt transmission after setting a delay period for medium access (e.g., a random backoff period) and waiting without starting transmission. By applying a random backoff period, multiple devices are expected to attempt transmission after waiting for a different time, so collision may be minimized.

In addition, when a superframe structure is applied, a slotted CSMA-CA mechanism may be applied to data transmission in the contention access period (CAP) of an active portion between the active portion and the inactive portion of an interval between beacons. A CSMA-CA mechanism may not be applied to data transmission in an active portion and in a contention free period (CFP). When a superframe structure is not applied, an unslotted CSMA-CA mechanism may be applied to the transmission of all data frames excluding an ACK frame for a data request command.

### Ranging Measurement

Ranging includes distance measurement between two devices, and a device having a ranging capability may be referred to as a ranging-capable device (RDEV) or an enhanced ranging-capable device (ERDEV).

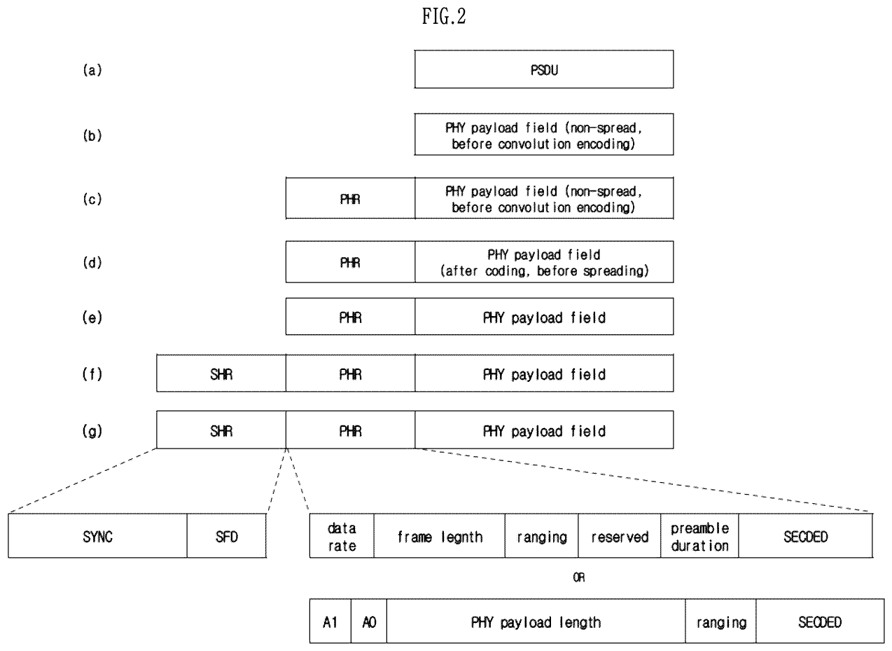

FIG. 2 is a diagram for describing a HRP UWB PPDU format to which the present disclosure may be applied.

FIGS. 2(a) to 2(g) show the encoding process of a HRP UWB PPDU. Through an encoding process, a HRP UWB PPDU having a format including a synchronization header (SHR), a PHY header (PHR) and a PHY payload field may be generated.

FIG. 2(a) shows a PHY service data unit (PSDU) received from a MAC through a PHY service access point (SAP). A PSDU may include a MAC PDU.

In FIG. 2(b), Reed-Solomon encoding may be applied to a PSDU, generating a PHY payload field. A PHY payload field in FIG. 2(b) is non-spread, and corresponds to a status before convolution encoding is applied.

In FIG. 2(c), a PHR field may be added in front of a PHY payload field. A PHR field may have a size of 19 bits of bit 0 to bit 18. For example, bit 0-1 may correspond to a data rate field, bit 2-8 may correspond to a frame length field, bit 9 may correspond to a ranging field, bit 10 may be reserved, bit 11-12 may correspond to a preamble duration field and bit 13-18 may correspond to a single error correct, double error detect (SECDED) field. A data rate field may indicate a data rate value applied to a PHY payload field. A frame length field may indicate the length of a PSDU. A ranging field may indicate whether a corresponding frame is a ranging frame (RFRAME). A preamble duration field may indicate the length (symbol unit) of the SYNC field of a SHR.

In FIG. 2(d), convolution encoding may be applied to generate a coded PHY payload field, and spreading may be applied to a PHY payload field in FIG. 2(e).

In FIG. 2(f), a SHR may be added in front of a PHR. A SHR field may include a SYNC field (or a preamble code) and a start-of-frame delimiter (SFD) field.

In FIG. 2(g), modulation is applied to SHR, PHR and PHY payload fields, and a PPDU encoding procedure is terminated. A basic coding rate may be applied to a SHR field. A PHR field may have a format including data rate (2 bits), frame length (7 bits), ranging (1 bit), reserve (1 bit), preamble duration (2 bits) and SECDED (6 bits) for a base pulse repetition frequency (BRFP) mode, or may have a format including A1 (1 bit), A0 (1 bit), PHY payload length (10 bits), ranging (1 bit) and SECDED (6 bits) for a higher pulse repetition frequency (HPRF) mode. The A1 and A0 fields may also indicate the size of an additional gap between a payload and a STS. For a PHR field, burst position modulation-binary phase shift keying (BPM-BPSK) with a coding rate of 850 kb/s or 6.8 Mb/s may be applied in a BPRF mode, and modulation with a coding rate of 3.9 Mb/s, 7.8 Mb/s, 15.6 Mb/s or 31.2 Mb/s may be applied in a HPRF mode, and BPM-BPSK with 850 kb/s or 110 kb/s may be applied in other cases. For a PHY payload field, modulation with a coding rate of 6.8 Mb/s, 7.8 Mb/s, 27.2 Mb/s or 31.2 Mb/s may be applied in a HPRF mode, and BPM-BPSK with a coding rate indicated in a PHR may be applied in other cases.

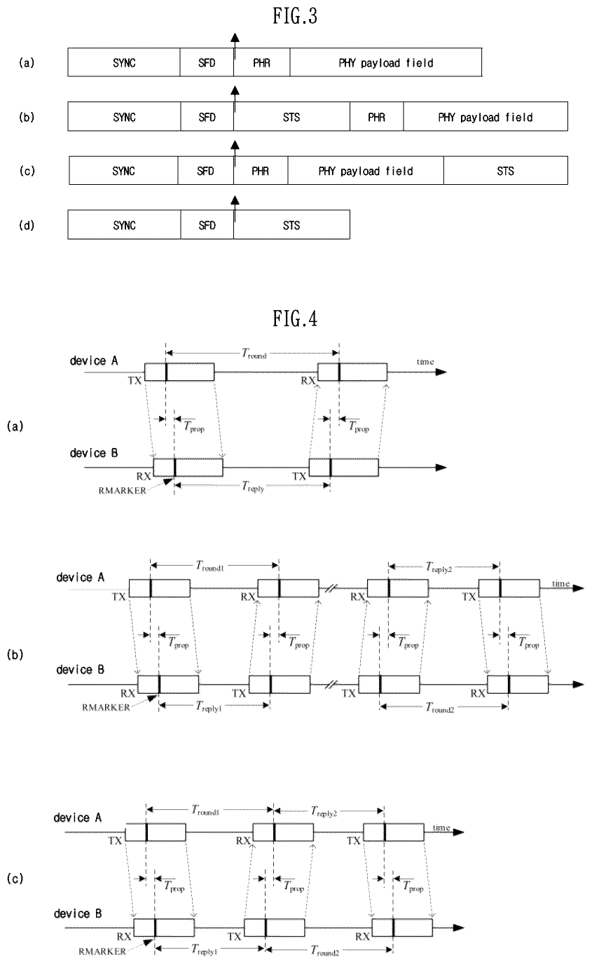

FIG. 3 is a diagram representing a RMARKER position according to a STS packet configuration in a HRP-ERDEV PPDU format to which the present disclosure may be applied.

A scrambled timestamp sequence (STS) field may include a sequence of pseudo-randomized pulses. For example, a STS may include a sequence of advanced encryption standard (AES)-128-based pseudo-randomized pulses, and may be utilized for accurate localization in the localization technology based on the spread spectrum technology in UWB communication.

A PPDU STS packet structure configuration may be different according to whether a STS field is included and its location.

FIG. 3(a) shows a format corresponding to STS packet configuration 0 (i.e., a STS field does not exist in a PPDU). This format may be defined in a mandatory way.

FIG. 3(b) shows a format corresponding to STS packet configuration 1 (i.e., a STS field is located immediately after a SFD field and before a PHR field). This format may be defined in a mandatory way.

FIG. 3(c) shows a format corresponding to STS packet configuration 2 (i.e., a STS field is located after a PHY payload field). This format may be defined in an optional way.

FIG. 3(d) shows a format corresponding to STS packet configuration 3 (i.e., a STS field is located immediately after a SFD field, a PHR field does not exist, and a data field (i.e., a PHY payload field) does not exist). This format may be defined in a mandatory way.

A PPDU format like examples in FIG. 3 may be referred to as a HRP-ERDEV PPDU format. In FIG. 3, an arrow indicates a ranging marker (RMARKER) reference position in each format. RMARKER may be a reference for timestamp measurement or ranging counter.

For example, RMARKER may be defined as a time at which the start of the first symbol following the SFD of RFRAME is at a local antenna. The next higher layer may estimate a relative clock offset between local reference clocks on a remote transmitting end and a receiving end based on the reporting of a SRMARKER receiving ranging counter value for at least one STS segment.

A ranging counter supported by RDEV corresponds to a set of behavioral properties and capabilities of a RDEV calculating a ranging counter value. A ranging counter value is an unsigned integer, and may be defined as a length of at least 32 bits. The unit of a ranging counter is defined as 2-7 of a 499.2 MHz chipping period for a HRP UWB PHY, and is approximately 15.65 picoseconds (ps), and is defined as 20⁻²⁰ of a 1 MHz basic chipping rate for a LRP UWB PHY, and is approximately 0.9537ps.

A ranging capability may be enabled in a RDEV by using a MAC common part sublayer (MCPS)-DATA.request primitive and a MAC sublayer management entity (MLME)-RX-ENABLE.request primitive. A primitive may mean a set of instructions or parameters exchanged between sublayer entities or layers within one device. For example, an originator may request a ranging capability through a MCPS-DATA.request primitive, and a ranging capability may be enabled in a recipient through a MLME-RX-ENABLE.request primitive.

### Ranging and Localization Method

The ranging and localization methods supported by RDEVs and ERDEVs may be based on a time-stamping capability. As a time-based technique, single-sided two-way ranging (SS-TWR), double-sided two-way ranging (DS-TWR), and one-way ranging/time difference of arrival (OWR/TDOA) are described below.

FIG. 4 is a diagram for describing two-way ranging techniques to which the present disclosure may be applied.

In the example of FIG. 4(a), SS-TWR includes the measurement of the round-trip delay of a single message from one device to another device and a response sent to a sending device. Device A initiates message exchange, device B sends a response, and T_prop corresponds to the propagation time of RMARKER between devices.

Each device precisely measures the transmission and reception time of a message frame, and accordingly, may calculate T_round and T_reply by simple subtraction. The resulting TOF may be estimated as \hat{ }T_prop by the following equation.

$${\hat{T}}_{prop} = \frac{1}{2} ( {T}_{round} - {T}_{reply} ) \qquad [ Equation 1 ]$$

When a device may estimate a relative clock offset between itself and a remote device, the accuracy of TOF may be improved by the following equation.

$${\hat{T}}_{prop} = \frac{1}{2} ( {T}_{round} - {T}_{reply} - ( 1 - {C}_{offs} ) ) \qquad [ Equation 2 ]$$

Here, C_offs corresponds to a value obtained after the receiver of device A measures a relative clock offset between itself and the transmitter of remote device B.

In the example of FIG. 4(b), DS-TWR corresponds to the extension of SS-TWR, and two round-trip times may be used and combined to calculate a TOF result by reducing an error for a case where an uncorrected clock frequency offset exists although a response delay is long. Device A initiates the first round-trip time measurement, and device B responds to it, and then device B initiates the second round-trip time measurement, and device A responds to it, so the entire DS-TWR exchange may be completed. T_prop corresponds to the propagation time of RMARKER between devices.

Each device precisely measures the transmission and reception time of a message frame, and accordingly, may calculate T_round and T_reply by simple subtraction. The resulting TOF may be estimated as \hat{ }T_prop by the following equation.

$${\hat{T}}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad [ Equation 3 ]$$

The example of FIG. 4(c) corresponds to the reduction of DS-TWR through four messages in FIG. 4(b) to three messages. In other words, the response of the first round-trip time measurement may be used as the initiation message of the second round-trip time measurement.

Next, a TDOA method is described. TDOA corresponds to a technique for locating a wireless device (e.g., a radio frequency identification (RFID) device) based on the relative arrival time of a single message or multiple messages. OWR may be used for TDOA. There are two cases of TDOA. In one case, a message is periodically broadcast by a mobile device, and a time at which a broadcast message arrives at multiple fixed nodes synchronized in a predetermined manner may be compared. Generally, a message transmitted by a mobile device may be referred to as a blink. In another case, multiple synchronized nodes may sequentially broadcast a message according to a transmission time offset known to each other. For any pair of fixed synchronized nodes, a difference in the arrival time of blinks in the first case, or a difference in the arrival time of broadcast messages received by a mobile device in the second case locates a mobile device on a hyperbolic surface. By combining results from such multiple pairs, an intersection point between sets of hyperbolic surfaces may be derived, and accordingly, the location of a mobile device may be specified. In the second case, a transmission offset may be considered when calculating a difference in the arrival time of messages from synchronized nodes.

RFID devices may typically use the shortest blink message as much as possible (e.g., a multipurpose frame) to reduce power consumption. A multipurpose frame may be 12 octets long, and may include a short frame control field and a sequence number field, and may not include a destination address field, an extended source address field and a frame check sequence (FCS).

The synchronization of fixed nodes may be performed by the wired distribution of clock signals, and a wireless synchronization technique may be applied. The UWB messages (and known/pre-measured TOF) transmitted between fixed nodes may be used to calculate a relative clock frequency offset and a drift between fixed nodes. This information may be used to correct the arrival time of blink messages based on a common time, making TDOA data meaningful.

### Set-Up Procedure Before Ranging Exchange

In order to reduce power consumption, disabling ranging may be defined as a default status. Enabling ranging in all RDEVs participating in TWR exchange may be performed by a higher layer. In addition, when an optional capability is used, it may be assumed that predetermined coordination for preamble and channel selection is performed before TWR exchange.

Finish-Up Procedure after Ranging Exchange

At the end of TWR exchange, each device may have transmit (TX) and receive (RX) ranging counter values related to round-trip time measurement or reply time. In order to calculate TOF, all of these values are required in a node where calculation is performed. For this purpose, out-of-band (OOB) signaling, a custom message, a ranging measurement information (RMI) information element (IE), etc. may be used.

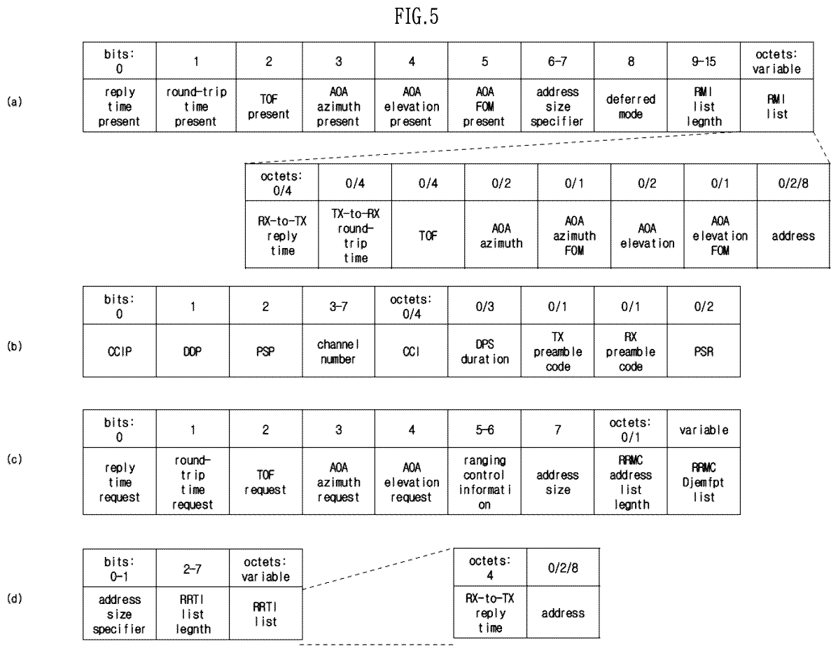

FIG. 5 is a diagram for describing examples of a format of a RMI IE, a RCPCS IE, a RRMC IE and a RRTI IE to which the present disclosure may be applied.

FIG. 5(a) shows an example of a RMI IE format.

A RMI IE may be used to send at least one ranging-related measurement to at least one device. A RMI IE content field may have the same format as the example of FIG. 5(a).

1, a value of a reply time present field, may indicate that a RX-to-TX (or TX-to-RX) reply time field is present in each RMI list element, and a value of 0 may indicate that it is not present. A RX-to-TX (or TX-to-RX) reply time may correspond to T_reply described by referring to FIG. 4.

1, a value of a round-trip time present field, may indicate that a TX-to-RX round-trip time field is present in each RMI list element, and a value of 0 may indicate that it is not present. A TX-to-RX round-trip time may correspond to T_round described by referring to FIG. 4.

1, a value of a TOF present field, may indicate that a TOF field is present in each RMI list element, and a value of 0 may indicate that it is not present.

1, a value of an AOA azimuth present field, may indicate that an AOA azimuth field is present in each RMI list element, and a value of 0 may indicate that it is not present.

1, a value of an AOA elevation present field, may indicate that an AOA elevation field is present in each RMI list element, and a value of 0 may indicate that it is not present.

1, a value of an AOA figure of merit (FOM) present field, may indicate that an AOA azimuth FOM field is present in each RMI list element when an AOA azimuth field is present, and may indicate that an AOA elevation FOM field is present in each RMI list element when an AOA elevation field is present, and a value of 0 may indicate that an AOA azimuth FOM field or an AOA elevation FOM field is not present.

An address size specifier field may specify the size of addresses used in a RMI list field (e.g., 2 or 8).

0, a value of a deferred mode field, may indicate that a corresponding RMI IE is embedded into RFRAME, and a value of 1 may indicate that a corresponding RMI IE is included in a deferred message transmitted in the next measurement report phase.

A RMI list length field may specify the number of elements of a RMI list field. Fields included in a RMI list field are as shown in FIG. 5(a).

FIG. 5(b) shows an example of a RCPCS IE format.

A ranging channel and preamble code selection (RCPCS) IE may be used to indicate channel selection for dynamic preamble code and channel selection (DPS) and/or selection of a TX/RX preamble code. DPS may include changing a long preamble to protect against an attacking device intercepting ranging. A RCPCS IE content field may have the same format as the example of FIG. 5(b).

1, a value of a CCI present (CCIP) field, may indicate that a CCI field is present, and a value of 0 may indicate that it is not present.

1, a value of a DPS Duration Present (DDP) field, may indicate that a DPS duration field is present, and a value of 0 may indicate that it is not present.

1, a value of a preamble sequence selection present (PSP) field, may indicate that preamble sequence selection fields, i.e., a TX preamble code field, a RX preamble code field and a preamble symbol repetitions (PSR) field, are present, and a value of 0 may indicate that they are not present.

A channel number field may indicate an UWB channel number for forthcoming ranging exchange.

A channel configuration interval (CCI) field may specify a channel configuration interval. A channel configuration interval may correspond to a time in the unit of a ranging scheduling time unit (RSTU) between the transmission of a corresponding IE and reconfiguration for a specified channel.

A RSTU corresponds to 416 chips (approximately 833.33 ns) (416 chips=416/499.2*106) for a HRP UWB PHY. A RSTU corresponds to 1 microsecond (us) (=1 chip at a 1 MHz basic chipping rate) for a LRP UWB PHY.

A DPS duration field may specify the effective time duration of DPS. A corresponding duration may be specified in the unit of a RSTU for an ERDEV and in the unit of a symbol for a non-ERDEV.

A TX preamble code field may indicate a DPS preamble code that will be used for transmission during the forthcoming ranging exchange on a side transmitting a corresponding IE.

A RX preamble code field may indicate a DPS preamble code that will be used for reception during the forthcoming ranging exchange on a side transmitting a corresponding IE.

A PSR field may indicate the number of preamble symbol repetitions that will be used for the SYNC of each RFRAME of the forthcoming ranging exchange.

A MLMR-DPS.request and MLME-DPS.confirm primitive may be applied to the optional DPS mode of ranging. The ConfigTime parameter of a MLME-DPS.request primitive may be used to specify a future time to which a preamble code and/or a channel number will be applied. A time to which a DPS change will be applied may be exchanged through the CCI field of a RCPCS IE.

### Basic Ranging Exchange

A recipient may turn on or enable ranging in a MAC on a recipient side based on a MLME-RX-ENABLE.request primitive from the next higher layer.

After ranging is turned on in a MAC on a recipient side (i.e., receiving a MLME-RX-ENABLE.request primitive), all received RFRAMEs may generate a TX/RX ranging counter.

An originator may transmit data to a recipient based on a MCPS-DATA.request primitive.

A recipient may generate a ranging report for all RFRAMEs and transmit an ACK frame to an originator.

An originator may enable Tx-to-Rx turnaround (i.e., repeat data transmission and ACK reception) by receiving an ACK frame from a recipient. In this regard, the next higher layer may not be involved.

A ranging report may include the issue of a MCPS-DATA.confirm primitive on an originator side (i.e., reporting the result of invoking a MCPS-DATA.request primitive) and the issue of a MCPS-DATA.indication primitive on a recipient side (i.e., indicating the reception of data from an originator, or indicating that ranging information according to the reception of a packet from an originator is available).

Until ranging is disabled, the generation of the ranging report of a recipient, the transmission of ACK to an originator, the enabling of Tx-to-Rx turnaround based on the reception of the ACK frame of an originator and a ranging report may be repeated.

### Ranging Procedure

First, the control of ranging and the transmission (transfer) of results are described.

A measurement value may be exchanged between RDEVs to complete ToF calculation. For this purpose, TWR may be controlled through information elements and ranging data may be exchanged between RDEVs.

Specifically, information elements may be used for the control of TWR and the transmission of ranging data between RDEVs participating in ranging exchange. For various ranging methods, according to a required use case, a measurement result by both devices may be combined to complete TOF calculation between RDEVs participating in ranging exchange. In other words, one device may transmit its ranging measurement result to another device. Information elements may be specified to provide a mechanism for controlling TWR and support the transmission of ranging information between devices participating in ranging exchange. In order to ensure the integrity of corresponding information transmission, a secure private data communication capability may be used.

Hereinafter, a ranging procedure for SS-TWR that applies a deferred reply time result is described.

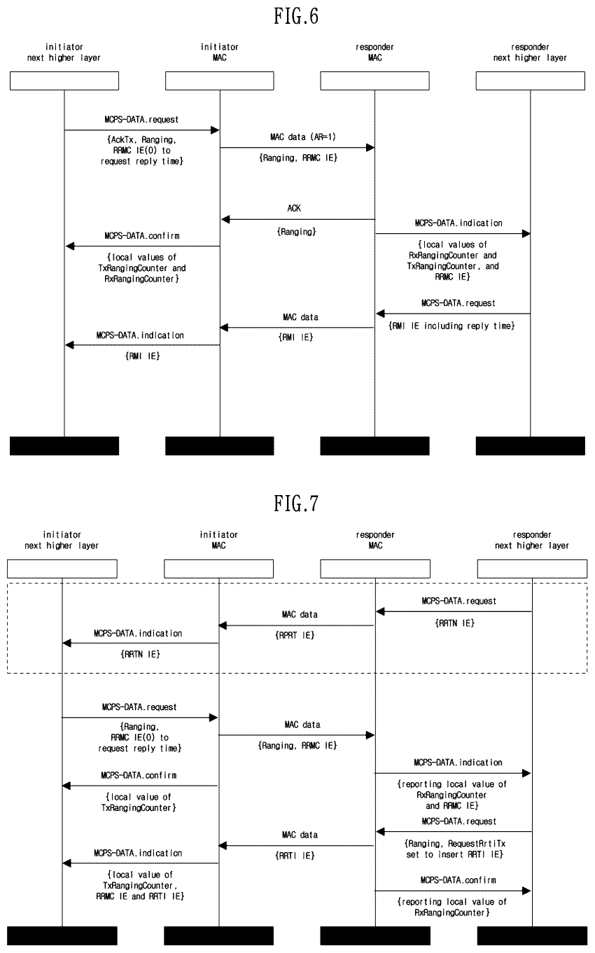

FIG. 6 shows an example of a message sequence chart for SS-TWR applying a deferred reply time result to which the present disclosure may be applied.

In a message sequence chart for ranging exchange, RRMC IE(0) may represent a RRMC IE including a ranging control information field with a value of 0 (i.e., a ranging initiation message for SS-TWR). The Acknowledgment Request (AR) field of a MAC header may represent whether ACK is requested.

The next higher layer of an initiator may have sufficient information for calculating TOF between devices by using the above-described equation at a time when receiving a RMI IE (e.g., FIG. 5(a)).

The ranging exchange initiation of an initiator may invoke a MCPS-DATA.request primitive to request ranging reply time information and transmit a ranging frame including a Ranging Request Measurement and Control (RRMC) information element including a ranging control information field.

FIG. 5(c) shows an example of a RRMC IE format.

A RRMC IE may transmit a ranging request and include information controlling a ranging procedure.

The reply time request, round-trip time request, TOF request, AOA azimuth request and AOA elevation request fields of a RRMC IE format may indicate that corresponding information is requested when that value is 1 and may indicate that corresponding information is not requested when that value is 0.

A ranging control information field may indicate that a corresponding frame is a ranging initiation message for SS-TWR when that value is 0, that a corresponding frame is a response to a ranging initiation message for SS-TWR when that value is 1, that a corresponding frame is a ranging initiation message for DS-TWR when that value is 2 and that a corresponding frame is continuing DS-TWR and initiates the second round-trip time measurement when that value is 3.

A address size field may specify the size of addresses used in a RRMC address list field. When the value of an address size field is 0, all addresses of a RRMC address list element may correspond to a short address. When the value of an address size field is 1, all addresses of a RRMC address list element may correspond to an extended address.

A RRMC address list length field may indicate the number of addresses of a RRMC address list field. When an address is not provided (e.g., for unicast ranging where a target device may be identified by a destination address in a MAC header (MHR)), a RRMC address list length field may be omitted.

When a RRMC IE is a broadcast message, and when a transmitter wants to receive a response to a ranging request from all devices, RRMC address list length and RRMC address list fields may be omitted. Alternatively, when a transmitter wants to receive a response to a ranging request from specific devices (or a device set), RRMC address list length and RRMC address list fields may be used to select a device set for a response.

For SS-TWR, since an initiator generally calculates TOF, a responder may request a TOF result by setting the TOF request field of a RRMC IE included in a response message.

For DS-TWR, since a responder generally calculates TOF, an initiator may request a TOF result by including a RRMC IE in two messages transmitted to perform DS-TWR exchange.

When an initiator requests different information from multiple responders, multiple RRMC IEs may be included in one broadcast message.

A RRMC address list field may include a list of addresses for which a RRMC IE heads.

In relation to a ranging report (or a response ranging frame), an initiator side may complete round-trip time measurement, and a MCPS-DATA.confirm primitive may provide an initiator side with a ranging report defining a round-trip time. On a recipient side, a MCPS-DATA.indication primitive may provide a ranging report on a response side defining a reply time for round-trip time measurement.

FIG. 5(d) shows an example of a Ranging Reply Time Instantaneous (RRTI) IE format.

In association with at least one frame including a RRMC IE where a reply time request field is set as 1, a RRTI IE may be included in a corresponding response frame to transmit the reply time of a response frame.

An address size specifier field may be defined as in the following table.

TABLE 1

| A value of an address size | |
|---|---|
| specifier field | Address Size |
| 00 | 0 Octet, no address |
| 01 | Reserved |
| 10 | 2 Octets, short address (16 bits) |
| 11 | 8 Octets, extended address (64 bits) |

A RRTI list length field may indicate the number of elements in a RRTI list field. A RRTI list field may include RRTI list elements.

The RX-to-TX reply time field of a RRTI list field may be set as a value indicating a difference between the transmission time of a response RFRAME including a RRTI IE and a reference time specified by a higher layer (i.e., T_reply in the example of FIG. 4(a)). A reference time may correspond to the reception time (based on RMARKER) of RFRAME including a RRMC IE where a reply time request field is set as 1.

The address field of a RRTI list field may be set as the address of a device transmitting a RRMC IE requesting a reply time. An address field may be omitted in unicast ranging. In scheduled multi-node ranging, when the reply time of other RDEVs are negotiated in advance and the order is determined, an address field may be omitted.

Hereinafter, a ranging procedure for SS-TWR that applies an embedded reply time result is described.

FIG. 7 shows an example of a message sequence chart for SS-TWR applying an embedded reply time result to which the present disclosure may be applied.

For SS-TWR applying a reply time result, ranging exchange may be initiated by a ranging frame requesting ranging reply time information and including a RRMC IE where a ranging control information field is set as 0. A responding device may complete round-trip measurement by transmitting a response frame including an embedded ranging reply time instantaneous (RRTI) IE. When a device has a capability to generate a RRTI IE, the number of messages required for ranging measurement may be minimized, so power may be saved. However, it may take time to calculate the arrival time of a received ranging message and prepare a RRTI IE value. In some cases, this time may be known a priori in an OOB manner, and a ranging reply time negotiation (RRTN) IE may provide a device with a mechanism that indicates a preferred reply time, i.e., a time required to prepare a frame including a RRTI IE. When this time is known, a ranging initiating device may expect a response message after a specific time, and may save energy by delaying turning on a receiver until then. This may be applied to both SS-TWR and DS-TWR ranging exchanges.

In FIG. 7, RRMC IE(0) represents a RRMC IE including a ranging control information field with a value of 0. The communication of a RRTN IE in a box indicated with dotted lines may be performed at any convenient time before ranging exchange is initiated, or preferred reply time information may be pre-known or exchanged through OOB. When receiving a MCPS-DATA.indication primitive including the RRTI IE of a responder, the next higher layer of an initiator may have sufficient information to calculate TOF between two devices according to the above-described equation.

Hereinafter, a ranging procedure for SS-TWR to which a fixed reply time is applied is described.

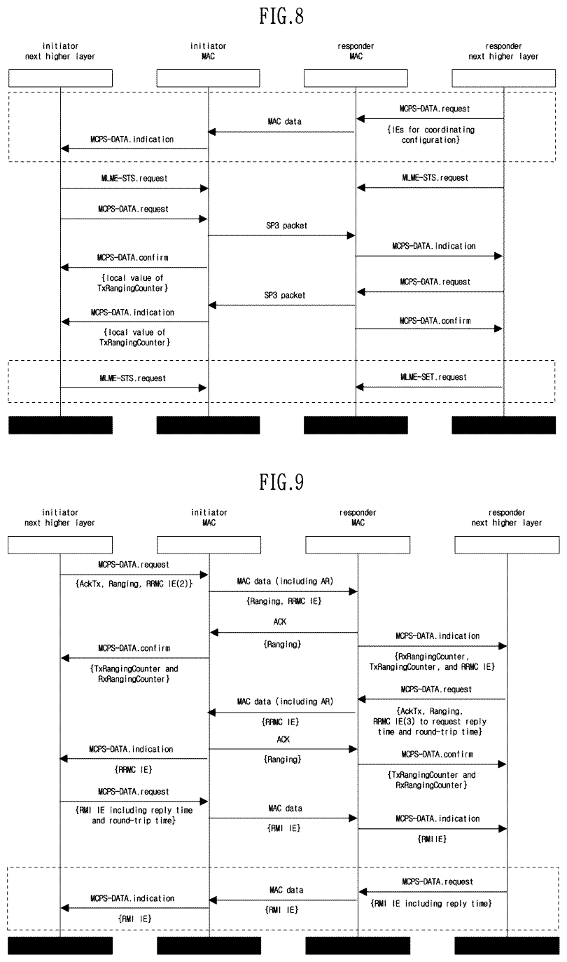

FIG. 8 shows an example of a message sequence chart for SS-TWR using a SP3 (scrambled timestamp sequence packet configuration option three) packet to which the present disclosure may be applied.

When a responding device is capable of precise control over the transmission time of its response message to the arrival time of a ranging initiation message, a reply time (i.e., Treply) may have a fixed known value agreed between devices participating in ranging exchange. In this case, it may not be required to embed Treply in a response message or to transmit it separately in an additional message. The accuracy of resulting ranging may depend on how much precise control a responding device has over the transmission time of its response message. For example, each 1 ns error in TOF may correspond to a ranging error of about 30 cm.

HRP-ERDEV PPDU format SP3 may be used for a fixed reply time.

In the example of FIG. 8, an initiation message in a box indicated with dotted lines may represent communication for agreement and coordination for all other parameters required to allow communication to proceed and the use of a SP3 packet between devices. In the example of FIG. 8, only a single message is indicated, but there may be a series of messages in each direction for an agreement on all parameters. For example, a RRNT IE may be used to agree on a fixed reply time.

In each device, the next higher layer may configure a SP3 packet format in all devices, and may appropriately configure an operation by using a MLME-STS.request primitive in order to set a personal area network information base (PIB) attribute (e.g., phyHrpUwbStsKey, phyHrpUwbStsVCounter, phyHrpUwbStsVUpper96, etc.). When a higher layer selects a SP3 packet configuration, subsequent MCPS-DATA primitives are related to a SP3 packet until a higher layer uses a MLME-STS.request primitive to change a packet configuration.

A MCPS-DATA. request primitive may be used to initiate ranging exchange, and in a corresponding mode, a PPDU may not convey MAC data. Although not shown, it may be assumed that the invocation of a MLME-RXENABLE.request primitive turns on a receiver at an appropriate time to receive a PPDU. Since a PHY is configured for a SP3 packet, a PHY may notify a MAC layer of the reception of a PPDU at the end of a scrambled timestamp sequence (STS), and a MAC similarly aware of a SP3 configuration may deliver the RxRangingCounter value of a RangingReportDescriptor parameter of a MCPS-DATA.indication primitive. In addition, when it is assumed that the RangingStsFom of RangingReportDescriptor is acceptable, a higher layer may initiate a response by invoking a MCPS-DATA.request primitive specifying RangingTxTime according to an agreed fixed reply time.

When a SP3 packet response is received in an initiating device, and it is assumed again that the RangingStsFom of the RangingReportDescriptor parameter of a MCPS-DATA.indication primitive is acceptable, an initiator side may have sufficient information to calculate TOF between devices according to the above-described equation based on a known fixed reply time.

Ranging exchange may be repeated multiple times until higher layers are mutually agreed. In order to resume PHY and MAC data interactions, the next higher layer may use a MLME-STS.request primitive to restore a STS packet configuration to a value that allows such data interactions. It is shown in a box indicated with final dotted lines in FIG. 8.

A LRP-ERDEV may also support challenge-response ranging to which a fixed reply time is applied in order to remove the need for a data message to convey a reply time.

Hereinafter, a DS-TWR ranging procedure to which deferred reply time information is applied is described.

FIG. 9 shows an example of a message sequence chart for DS-TWR to which deferred reply time information to which the present disclosure may be applied is applied.

DS-TWR may essentially include the completion of SS-TWR exchange initiated in each device, and a combination of its results. DS-TWR may be initiated by the next higher layer transmitting a ranging data frame conveying a RRMC IE (i.e., RRMC IE(2)) where the value of a ranging control information field is set as 2. This frame and its ACK may define the first round-trip time measurement. The delivery of a RRMC IE in a MCPS-DATA.indication primitive may be notified to the next higher layer to initiate the second round-trip time measurement by the transmission of a data frame in another direction. This data frame may include a RRMC IE (i.e., RRMC IE(3)) where the value of a ranging control information field is set as 3 to indicate the continuation of exchange, and both reply time request and round-trip time request fields may be set as 1 to request a reply time and the result of the first round-trip time measurement. ACK for this message may complete the second round-trip time measurement. A subsequent message from an initiator may convey the first round-trip time measurement result and the reply time of the second round-trip time measurement through a RMI IE. When receiving a MCPS-DATA.indication primitive (including a RMI IE), a responder may have sufficient information to calculate TOF between devices according to the above-described equation. The subsequent reporting of a ranging result to an initiator side by using a RMI IE may be performed according to the value of the TOF request field of an initiating RRMC IE.

Hereinafter, a DS-TWR ranging procedure that applies embedded ranging time information is described.

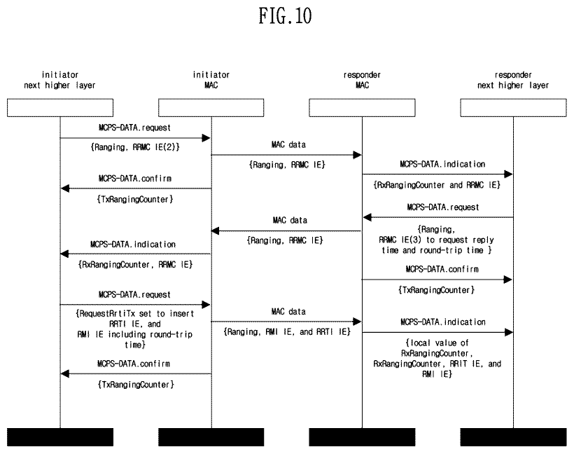

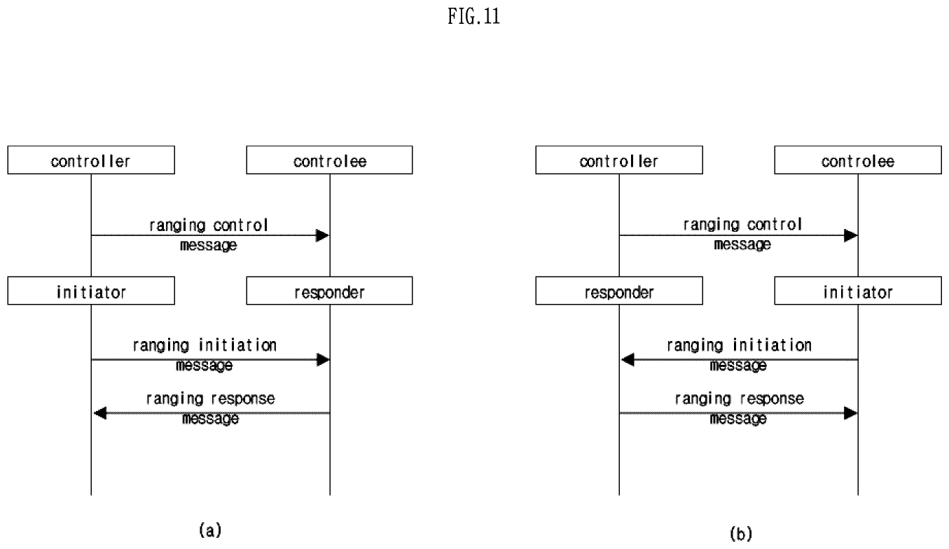

FIG. 10 shows an example of a message sequence chart for DS-TWR to which embedded ranging time information to which the present disclosure may be applied is applied.

For 3-message DS-TWR exchange in FIG. 4(c) described above, it is required that an initiator side may embed a reply time as a part of the completion of the second round-trip time measurement. In the example of FIG. 10, DS-TWR may be initiated by RFRAME conveying a RRMC IE (i.e., RRMC IE(2)) where a TOF request field is set as 0 (i.e., an initiator side does not request ranging report) and a ranging control information field is set as 2.

A responder side may complete the first round-trip time measurement, and initiate the second measurement by using RFRAME conveying a RRMC IE (i.e., RRMC IE(3)) where a ranging control information field is set as 3 to indicate the continuation of exchange. In this RRMC IE, both reply time request and round-trip time request fields are set as 1, so the result of the first round-trip time measurement and a reply time for the second round-trip time measurement may be requested. An initiator may complete exchange by transmitting a final RFRAME that includes the result of the first round-trip time measurement in a RMI IE and the reply time of the second round-trip time measurement in a RRTI IE.

When receiving the MCPS-DATA.indication primitive that is a higher layer, a responder may have sufficient information to calculate TOF between devices according to the above-described equation. When the initiator of ranging exchange wants a corresponding result, an initiator may set the TOF request field of an initiating RRMC IE as a value requesting a responder side to send a result in the RMI IE of a subsequent message at the end of the exchange.

Hereinafter, a different procedure for the coordination of a RDEV and an ERDEV will be described.

For the successful interoperation of a HRP-ERDEV when a STS is used, a transmitter and a receiver need to be arranged for a seed (i.e., a STS key and data value V) used in the generation of a STS in a transmitter and used in the generation of a sequence for correlating with a STS received in a receiver. For the coordination of these values, a secure private data communication capability may be used, and a seed may be transmitted between devices by using a Ranging STS Key and Data (RKSD) IE. A counter value in a RSKD IE may relate to a current packet or a future packet as indicated by the current packet (CP) field of a corresponding IE. A higher layer may use received RSKD IE information and configure a STS seed appropriately for future packet transmission and reception (e.g., through a PIB attribute such as phyHrpUwbStsKey, phyHrpUwbStsVUpper96, phyHrpUwbStsVCounter, etc.). The header IE version of a RSKD IE may be used to synchronize a STS generator by using information transmitted with a secured payload IE and data.

When a frame including a RSKD IE header IE is received, a corresponding IE may be delivered to the next higher layer to set an attribute such as phyHrpUwbStsKey, phyHrpUwbStsVUpper96, phyHrpUwbStsVCounter, etc. appropriately for STS generation. When a frame including a RSKD IE header IE does not pass the incoming security processing, for example, when a receiver does not have a key to validate a message integrity code (MIC), a RSKD IE may be delivered to the next higher layer through the HeaderIeList parameter of a MLME-COMM-STATUS.indication primitive.

### Multi-Node Ranging

Multi-node ranging may include ranging between at least two devices. Each device may perform a role in multi-node ranging.

FIG. 11 is a diagram for describing the role of a device in a ranging procedure to which the present disclosure may be applied.

A controller may correspond to a ERDEV that transmits a ranging control message (RCM) and defines a ranging parameter. A RCM may correspond to a data frame including an advanced control (ARC) IE. A controlee may correspond to an ERDEV that uses a ranging parameter provided by a controller through a RCM. An initiator corresponds to an ERDEV that sends the first message of ranging after a RCM and initiates ranging exchange, and a controller or a controlee may be an initiator. A responder corresponds to an ERDEV that responds to a ranging initiation message received from an initiator, and a controller or a controlee may be a responder.

The next higher layer of a controller may determine a ranging parameter and the role of an ERDEV participating in ranging exchange (i.e., an initiator or a responder).

For example, FIG. 11(a) shows an example in which a controller transmitting a ranging control message (RCM) is an initiator transmitting a ranging initiation message in ranging exchange and a controlee receiving a RCM is a responder receiving a ranging initiation message and transmitting a ranging response message in ranging exchange. FIG. 11(b) shows an example in which a controller transmitting a RCM is a responder receiving a ranging initiation message and transmitting a ranging response message in ranging exchange and a controlee receiving a RCM is an initiator transmitting a ranging initiation message in ranging exchange.

A ranging session may be defined as a group of ERDEVs involved in a consecutive ranging procedure configured by the initial set of a ranging parameter. A ranging session may include only one controller and at least one initiator. A controller may configure an initial ranging parameter and update a parameter during a ranging session.

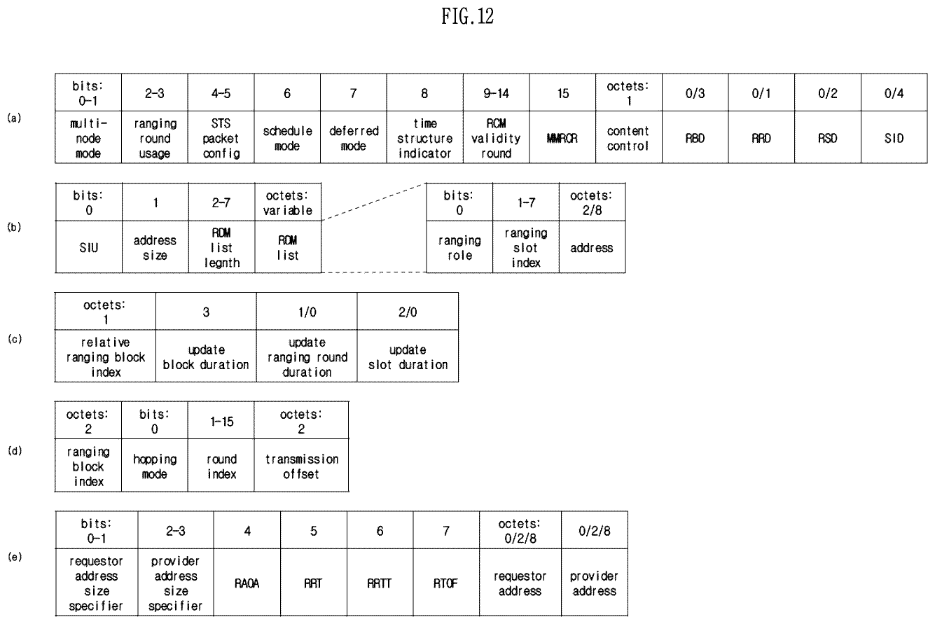

FIG. 12 shows examples of ARC IE, RDM IE, RBU IE, RR IE and SRRE IE formats to which the present disclosure may be applied.

FIG. 12(a) shows an example of a ARC IE format.

A controller may use an ARC IE to transmit ranging configuration information to a controlee. An ARC IE may be transmitted to one controller through a unicast frame and to a plurality of controllers through a broadcast frame.

A controlee may use an ARC IE to transmit its preferred ranging parameter to a controller together with a Ranging Change Request (RCR) IE.

Each field of an ARC IE may be defined as follows.

TABLE 2

| Value of multi-node mode | |
|---|---|
| field | Meaning |
| 0 | Single device-to-single device (unicast) |
| 1 | Multi-node one-to-many |
| 2 | Multi-node many-to-many |
| 3 | Reserved |

TABLE 3

| Value of ranging round | |
|---|---|
| usage field | Meaning |
| 0 | OWR(one-way ranging) |
| 1 | SS-TWR(single-sided two-way ranging) |
| 2 | DS-TWR(double-sided two-way ranging) |
| 3 | Ranging ancillary information exchange |

TABLE 4

| Value of STS packet | |
|---|---|
| configuration field | Resulting STS packet configuration |
| 0 | A STS field is not included in a PPDU (FIG. 3(a)) |
| 1 | STS Packet Structure #1 (FIG. 3(b)) |
| 2 | STS Packet Structure #2 (FIG. 3(c)) |
| 3 | STS Packet Structure #3 (FIG. 3(d)) |

TABLE 5

| Value of a | |
|---|---|
| schedule mode | |
| field | Selected ranging schedule mode and operation |
| 0 | Contention-based ranging is used for subsequent |
| | ranging rounds, and a RDM IE and a RCPS IE are used |
| | for control participation. |
| 1 | Scheduled-based ranging is used for subsequent ranging |
| | rounds, and participation in ranging and time slot |
| | allocation is fixed or controlled through the use of a |
| | RDM IE. |

A contention-based ranging type corresponds to a method in which a controller is unaware of the presence or number of controlees and accordingly, ERDEVs perform ranging in a contention-based manner. A collision may occur, so it may be required to filter an incorrect or wrong ranging result from a higher layer. An initiator or a responder may compete to perform transmission within an appropriate time slot. When an initiator and a responder compete, a ranging contention phase structure (RCPS) IE may be added to an ARC IE to designate a different phase (e.g., distinguished through a slot index) in a RCM. When a RCM is received, a controlee may know that it was selected to participate in a ranging round. A time-scheduled ranging type corresponds to a method in which a controller knows all controlees and designates the exact schedule of ranging transmission. A controller may select devices participating in ranging, give a ranging role (i.e., an initiator or a responder) and allocate a time slot through a ranging device management (RDM) IE. If the role and transmission schedule of a device are pre-designated by an OOB signaling method, etc., a RDM IE may be omitted.

TABLE 6

| Value of | |
|---|---|
| deferred mode | Whether a deferred mode is allowed in measurement |
| field | report |
| 0 | The round-trip measurement is completed immediately |
| | by embedding a RRTI IE in a response frame. |
| 1 | The round-trip time or reply time is reported in a |
| | measurement report phase. |

TABLE 7

| Value of time | |
|---|---|
| structure | |
| indicator field | Selected ranging time structure operation |
| 0 | A time structure is interval-based, and a RIU IE is used |
| | to control ranging interval update. |
| 1 | A time structure is block-based, and a RR IE is used to |
| | control ranging interval update. |

A RCM validity rounds field indicates the number of consecutive ranging rounds controlled by a RCM, which may be used to define a ranging round set. A multiple message receipt confirmation request (MMRCR) field may indicate whether multiple message receipt confirmation is requested.

A content control field may represent whether other fields are present in an ARC IE. Bits 0, 1, 2 and 3 of a content control field correspond to a field indicating whether a ranging block duration (RBD) field is present (i.e., RBDP), a field indicating whether a ranging round duration (RRD) field is present (i.e., RRDP), a field indicating whether a ranging slot duration (RSD) field is present (i.e., RSDP) and a field indicating whether a session ID field is present (i.e., SIP), respectively. Bits 4-7 of a content control field may be reserved. A RBD field may indicate the duration (RSTU unit) of a ranging block.

A RRD field may indicate the duration of a ranging round (a ranging slot unit, i.e., the number of ranging slots in a ranging round).

A RSD field may indicate the duration (RSTU unit) of a ranging slot.

A SID field may indicate a unique identifier for each controller.

When a ranging block structure is the same as a previously specified duration, at least one of the duration fields (e.g., a RBD field, a RRD field, a RSD field) may not be present in the ACI IE of a current RCM. Even in this case, other fields (e.g., a schedule mode field, a STS packet configuration field, etc.) may be used to update a corresponding ranging parameter.

FIG. 12(b) shows an example of a ranging device management (RDM) IE format.

A RDM IE may be used to exchange scheduling information between ERDEVs for a set of ranging rounds designated in a RCM with the same controller.

A slot index usage (SIU) field may indicate whether to use the slot index of a RDM list element. When a value thereof is 0, a RDM IE may be used to allocate a ranging role (i.e., an initiator or a responder) to controlee(s) for contention-based ranging. When a value thereof is 1, a RDM IE may be used to allocate a time slot and allocate a ranging role to controlee(s) for scheduling-based ranging.

An address size field represents the size of an address used for a RDM list field, and 0 may indicate that a short address (16 bits) is used and 1 may indicate that an extended address (64 bits) is used.

A RDM list length field may indicate the number of RDM list elements.

The ranging role field of a RDM list may indicate an initiator or a responder. The ranging slot index field of a RDM list may indicate a slot index allocated to the device of a corresponding address. The address field of a RDM list may indicate the address of each device participating in ranging.

FIG. 12(c) shows an example of a ranging block update (RBU) IE format.

A RBU IE may be used by a controller to notify controlee(s) of an updated ranging block structure.

A relative ranging block index field may indicate the number of residual ranging blocks according to a current configuration before switching to a new configuration.

An updated block duration field may indicate the duration (RSTU unit) of a new ranging block.

An updated ranging round duration field may indicate a ranging round duration value that is an integer multiple of a ranging slot duration within a new ranging block structure.

An updated ranging slot duration may indicate the duration (RSTU unit) of a ranging slot within a new ranging block structure.

FIG. 12(d) shows an example of a ranging round (RR) IE format.

A ranging block index field may indicate the index of a ranging block.

A hopping mode field may indicate whether a hopping mode is supported for a ranging block.

A round index field may indicate a ranging round index within a ranging block.

A transmission offset field may indicate the value (RSTU unit) of the transmission offset of a ranging round within a block. A transmission offset may have a value obtained by subtracting a packet duration from the maximum value of a slot duration as the maximum value.

For a current ranging round (i.e., a ranging round in a ranging block with a block index of i), a RR IE may be included in the RCM of a ranging block with a block index of i. In this case, a RR IE may correspond to information that an ERDEV supports synchronization for a block structure.

For the next ranging round (i.e., a ranging round in the next ranging block with a block index of i+1), when the last message of a current ranging round (i.e., a ranging block with a block index of i) is transmitted from a controller to controlee(s), a RR IE may be transmitted in a final message to indicate ranging round information for a ranging block with a block index of i+1.

When the last message in a current ranging round (i.e., a ranging block with a block index of i) is transmitted from a controlee, a controller may transmit a RR IE in the RCM of the next ranging block with a block index of i+1 to indicate ranging round information for a ranging block with a block index of i+2.

In this case, a RCM in a ranging block with a block index of i+1 may include two RR IEs. One RR IE may be applied to the ranging round of a ranging block with a block index of i+1, and the other RR IE may be applied to the ranging round of a ranging block with a block index of i+2.

FIG. 12(e) shows an example of a SP3 ranging request reports (SRRR) IE format.

A SRRR IE may be used to request the report of AOA and/or reply time and/or round-trip time measurement from a requestor to a provider.

Each of a requestor address size specifier field and a provider address size specifier field may have a value of 00, 01, 10 and 11 as in Table 1 described above, and may indicate that an address is not present or that a short address (16 bits) or an extended address (64 bits) is used.

A report of AOA (RAOA) field may indicate whether report on AOA is requested.

A report of reply time (RRT) field may indicate whether report on a reply time is requested.

A report of round-trip time (RRTT) field may indicate whether report on a round-trip time is requested.

A report of TOF (RTOF) field may indicate whether report on TOF is requested.

A requestor address field may be set as the address of a device transmitting a signal where AOA is measured or initiating ranging.

A provider address field may be set as the address of a device measuring AOA.

### Ranging Block and Round Structure

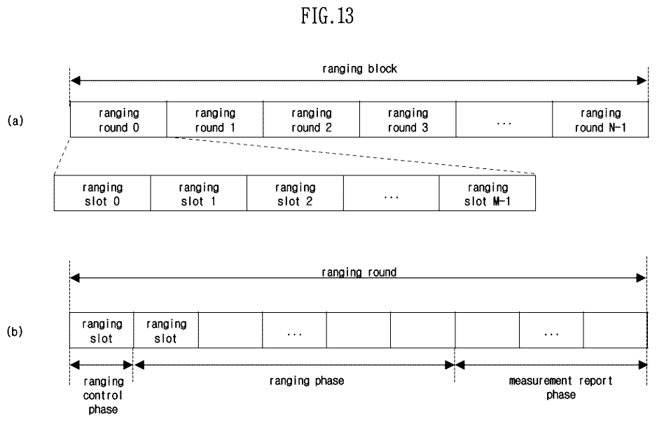

FIG. 13 is a diagram for describing a ranging block structure and a ranging phase to which the present disclosure may be applied.

In FIG. 13(a), a ranging block is a time duration for performing ranging, and one ranging block may include N ranging rounds.

A ranging round corresponds to a sufficient time for ERDEVs participating in ranging exchange to complete a ranging measurement cycle, and one ranging round may include M ranging slots.

A ranging slot may correspond to a time sufficient for transmission of at least one RFRAME.

The number of slots included in a slot duration and a ranging round may be different between ranging rounds. To this end, a controller may transmit a RCM that changes a ranging round configuration to controlee(s).

A ranging control message (RCM) is the first message transmitted by a controller, and may be transmitted in the first slot of a ranging round. A RCM may include configuration information for a ranging parameter.

A ranging control update message (RCUM) corresponds to a message transmitted by a controller in the last slot of ranging round(s) designated by a RCM in order to update a ranging parameter for the next ranging round(s). IE(s) included in a RCM for updating a ranging parameter may be included in a RCUM.

A ranging interval update message (RIUM) corresponds to a message transmitted by a controller to update an interval between ranging blocks and help synchronization between participating ERDEVs. A RCUM may include the scheduled time of the first RIUM, and a RIUM may include the scheduled time of the next RIUM (if used) before the start of the next ranging block.

FIG. 13(b) describes phases in a ranging procedure.

A ranging control phase (RCP) corresponds to a phase where a controller transmits a RCM.

A ranging phase (RP) may include a ranging initiation phase (RIP), a ranging response phase (RRP) and a ranging final phase (RFP).

A RIP corresponds to a phase where an initiator transmits ranging initiation message(s) to responder(s).

A RRP corresponds to a phase where responder(s) transmits response message(s) to an initiator.

A RFP corresponds to a phase where an initiator transmits ranging final message(s) to a responder, and may be used only in DS-TWR.

A measurement report phase (MRP) corresponds to a phase where participating ERDEVs exchange service information related to ranging measurement.

A ranging control update phase (RCUP) corresponds to a phase where a controller transmits a RCUM, and when a RCUP exists, a corresponding phase may be located in the last slot of the set of ranging rounds designated by a RCM.

A ranging interval update phase (RIUP) corresponds to a phase where a controller transmits a RIUM.

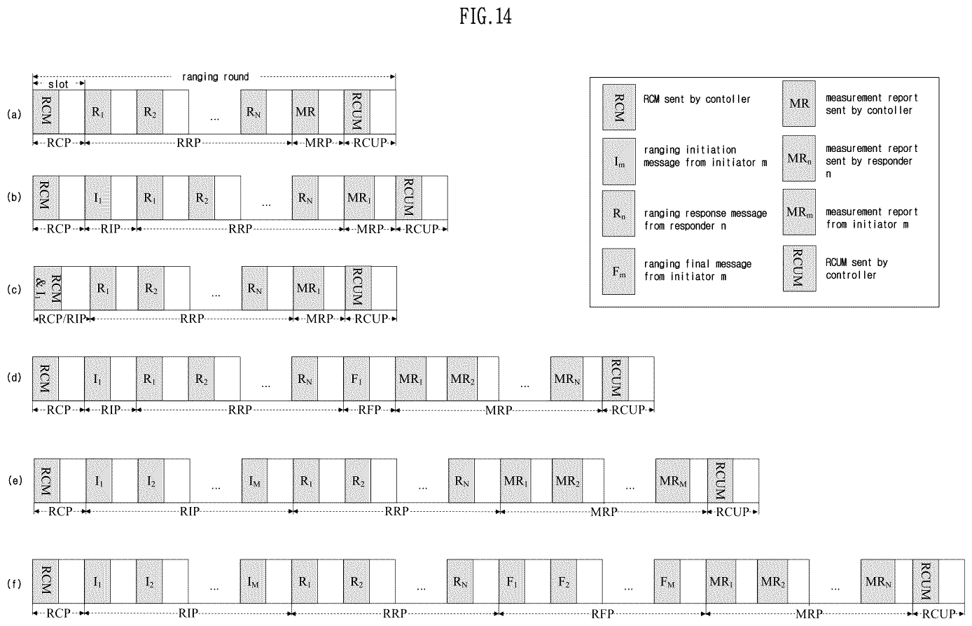

FIG. 14 shows examples of a timing diagram for various multi-device ranging to which the present disclosure may be applied.

FIG. 14(a) corresponds to the example of OWR, FIG. 14(b) corresponds to the example of SS-TWR, FIG. 14(c) corresponds to the example of the combination of a RCP and a RIP in SS-TWR, FIG. 14(d) corresponds to the example of DS-TWR, FIG. 14(e) corresponds to the example of many-to-many SS-TWR and FIG. 14(b) corresponds to the example of many-to-many DS-TWR.

Hereinafter, a ranging mode is described.

In an interval-based mode, the average time of ranging rounds is variable, and a time structure may be applied with adaptive spacing.

In a block-based mode, the average time of ranging rounds is constant. In other words, a ranging block with the same duration may be repeated in a block-based mode.

Ranging mode selection may be determined based on a time structure indicator field within an ARC IE or an OOB mechanism.

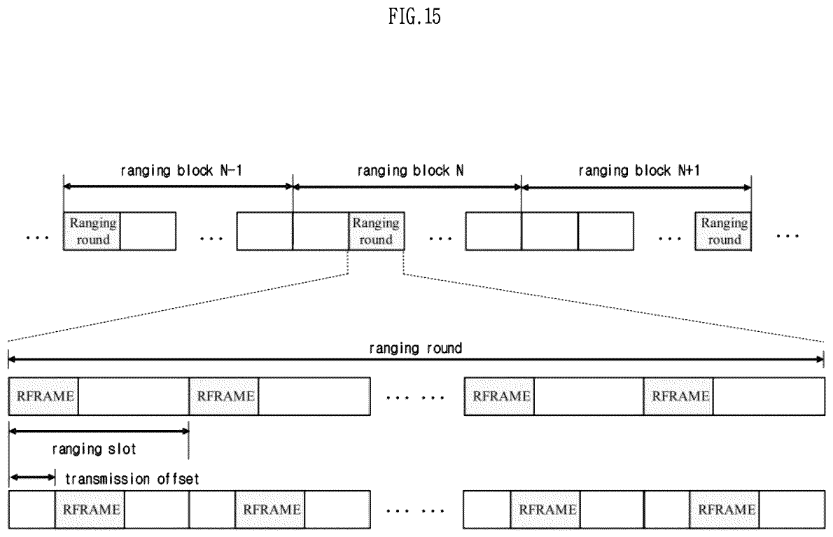

FIG. 15 shows a timing diagram in an example of a block-based mode to which the present disclosure may be applied.

In a block-based mode, a ranging block structure may use a structured timeline. A ranging block structure setup may include designating a ranging block duration (RBD), a ranging round duration (RRD) and a ranging slot duration (RSD) based on the corresponding field of an ARC IE.

The number of ranging rounds corresponds to a value obtained by dividing a ranging block duration by a ranging round duration.

The number of ranging slots corresponds to a value obtained by dividing a ranging round duration by a ranging slot duration.

An ERDEV receiving a RCM may set an associated timeline for ranging based on the value of fields in an initial ranging block structure and an ARC IE. A ranging block structure may be set up and/or fixed by the next higher layer.

A ranging block structure may be transmitted repeatedly by a controller for each RCM (e.g., through an ARC IE). When the change or update of a ranging block structure (i.e., a new ranging block duration, ranging round duration and/or ranging slot duration) is required, a controller may transmit a RBU IE for a new configuration. A RBU IE may be transmitted through a final data frame in a ranging message sequence or a RCM. Whenever a RBU IE is transmitted, a controller may decrease a relative ranging block index one by one until it becomes 0. Accordingly, it may be indicated whether a new configuration will be used in the next block and whether the RCM ARC IE of the next block includes a new configuration.

Hereinafter, indexing is described.

For a ranging block, a block index is given as 0 for the first ranging block, and a relative block index is determined for the remaining blocks by using block index 0 as a reference.

For a ranging round, when N ranging rounds are included in one ranging block, a round index is given as 0 for the first ranging round in a current ranging block, and a relative round index (e.g., 1, . . . , M−1) is determined for the remaining N−1 rounds by using round index 0 as a reference.

For a ranging slot, when M ranging slots are included in one ranging round, a slot index is given as 0 for the first ranging slot in a current ranging round, and a relative slot index (e.g., 1, . . . , M−1) is determined for the remaining M−1 slots by using slot index 0 as a reference.

The new ranging message exchange may be transmitted/received as the first RCM in the ranging slot with index 0 of the ranging round with index 0 of a ranging block with index 0. In other words, a RCM packet may be transmitted at the start of the first ranging slot of the first ranging round. A RCM may include a RR IE to inform information associated with ranging rounds within a current ranging block.

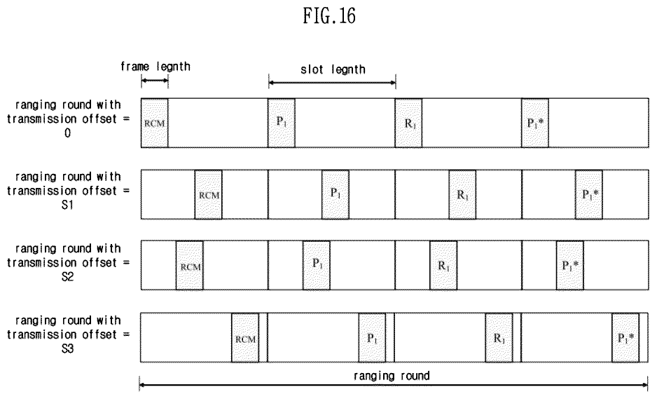

FIG. 16 is a diagram for describing examples of various transmission offsets to which the present disclosure may be applied.

A RR IE included in a RCM may include transmission offset information as information associated with a ranging round within a current ranging block. In subsequent ranging rounds, a controller may start transmission in each slot based on a different transmission offset. A transmission offset may have a value obtained by subtracting an UWB packet duration from a ranging slot duration. A transmission offset may be expressed as a multiple of a RSTU.

A transmission offset may be applied to a ranging round. In other words, the same transmission offset may be applied to all packet transmissions included in the same ranging round. In the next higher layer of a controller, a transmission offset may be selected and communicated to all other devices through a RR IE. A controller may also change a transmission offset for each ranging round based on power that reduces interference.

### One-to-Many Ranging Procedure

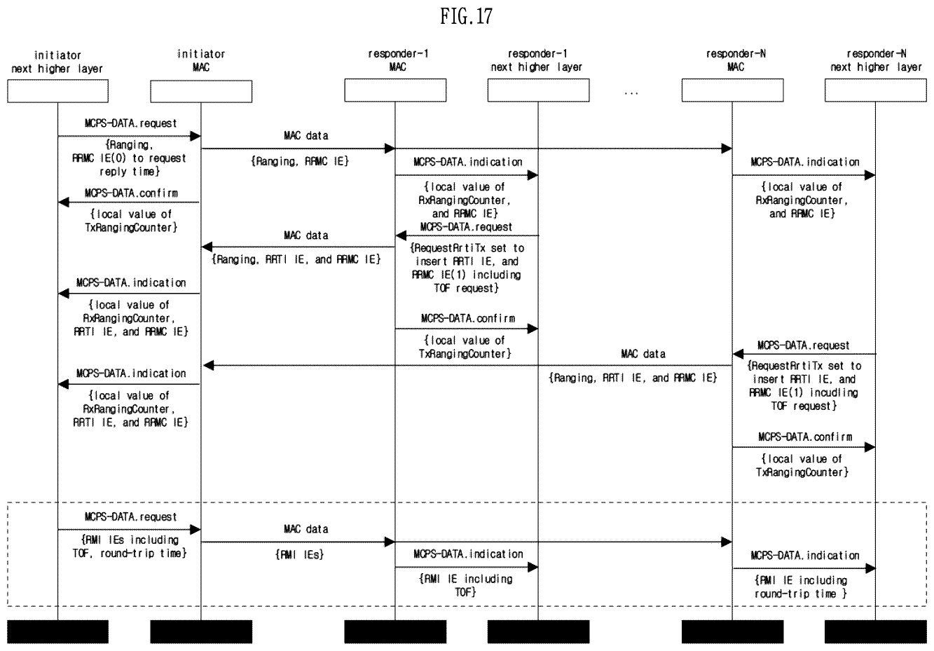

FIG. 17 shows an example of a message sequence chart for one-to-many SS-TWR to which the present disclosure may be applied.

In a ranging procedure for one-to-many TWR, ranging exchange may be initiated by an initiator transmitting a RRMC IE, and a RRMC IE may be included in a ranging initiation message broadcast to multiple responders.

A RRMC IE where a ranging control information field is set as 0 (i.e., RRMC IE(0)) may be transmitted as a SS-TWR ranging initiation message. The reply time request field of a RRMC IE may be set as 1 to request a reply time from a responding ERDEV.

A RRMC IE delivered through a MCPS-DATA. indication primitive from each of the responder-1 to responder-N may give a signal to the next higher layer that must perform a ranging response. Each responder may insert a RequestRrtiTxList parameter into a RRTI IE (as a response to the reply time request of a RRMC IE) and transmit a RRMC IE where a ranging control information field is set as 1 (i.e., RRMC IE(1)) to an initiator. Here, responding RFRAMEs may be transmitted to an initiator in a unicast manner.

When an initiator receives each ranging response frame, an initiator may have sufficient information to calculate the TOF of a corresponding responder.

The final message broadcast by an initiator may include at least one RMI IE(s) for measurement report (when requested by a RRMC IE). A plurality of RMI IEs may be distinguished by a device associated by an address field. For example, responder-1 may set a TOF request field in a RRMC IE as 1, and responder-N may set a round-trip time request field in a RRMC IE as 1. When multiple responders request the same information set like TOF, measurement report from an initiator may be performed through one RMI IE within a final data message.

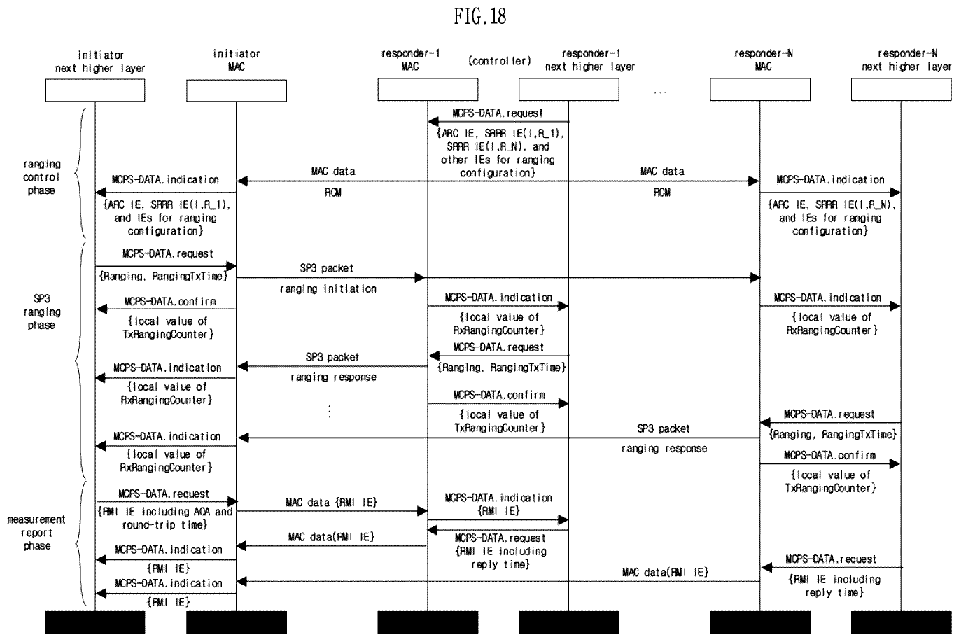

FIG. 18 shows an example of a message sequence chart for SP3 one-to-many SS-TWR to which the present disclosure may be applied.

At the start of a ranging round, a RCM may transmit ranging configuration information and an IE related thereto. A SRRR IE(I, R_1) may set RAOA and RRTT fields as 1 when responder-1 requests AOA and round-trip time from an initiator side.

Multi-node SP3 ranging may be based on scheduling designated by the next higher layer of a controller (i.e., each time slot is allocated to be used in a specific ERDEV).

A RDM IE in a RCM may include information that allocates time slots and device roles within a ranging round. An ARC IE may designate a ranging procedure and a SP3 packet format to make the next higher layer of an ERDEV to recognize the start and end of a SP3 ranging phase and invoke a MLME-STS primitive for enabling/disabling a SP3 packet before/after a ranging phase.

A RSKD IE for exchanging the parts of a STS seed for initializing STS generation between participating ERDEVs may be included in a RCM. According to the scheduling information of ranging transmission, the STS counter value of participating ERDEVs may be appropriately set for transmitting and receiving SP3 packets.

In a SP3 ranging phase, the next higher layer may appropriately set an operation on both sides by using MLME-STS.request to select a SP3 packet format and may set correct values for phyHrpUwbStsKey, phyHrpUwbStsVUpper96 and phyHrpUwbStsVCounter attributes. Since ranging scheduling is designated by a RCM preceding SP3 ranging, a device already knows a participant. Each time slot may be allocated to a specific (E) RDEV.

In a measurement report phase, an initiator may transmit AOA and round-trip time to responder-1 through a RMI IE. Responder-1 to responder-N may embed a requested reply time into a RMI IE sent to an initiator, respectively.

As another example, in the SP3 ranging phase of a message sequence for SP3 one-to-many DS-TWR, after receiving a SP3 frame as a ranging response message from each responder, an initiator may transmit a SP3 frame as a ranging completion message to each responder, through which the local value of an initiator's TxRangingCounter may be delivered to each responder. In a measurement report phase, an initiator may transmit a RMI IE including a reply time and a round-trip time to responders, and for this, each responder may transmit a RMI IE including AOA to an initiator.

### Narrowband Assisted (NBA)-UWB

In terms of MAC, NBA-UWB may be viewed as an umbrella feature including multiple semi-independent features. All of these features share some common principles, and among them, the most important thing is that tight clock synchronization exists between narrowband (NB) and UWB. A NB PHY and a UWB PHY should be driven by the same clock, and accordingly, an additional work may not be required to determine relative accuracy. When the same clock is not applied to a NB PHY and a UWB PHY, an explicit requirement for relative clock drift/accuracy between different PHYs/radios may be necessary. Based on tight coupling between NB and UWB, the following various features may be considered for UWB.
Initialization Channel: An initialization channel may correspond to a NB channel used for UWB channel discovery. The NB wireless technology may be used as a pilot for providing an additional CCA mode for UWB to the IEEE 802.15.4 series standard.

Meanwhile, a control channel is distinct from an initialization channel, and about 300 NB channels may be defined for a control channel.
Multi-millisecond (MMS) UWB (including security MMS): In MMS-UWB, data exchange and obtaining of carrier frequency offset (CFO)/sampling frequency offset (SFO) may be offloaded to a NB PHY. It may enable ToF accuracy refinement and link budget refinement.
NBA-TDOA: Link budget refinement and energy saving may also be applied to NBA-TDOA.
NBA-Sensing: NB may be applied to data exchange required for multi-static sensing.

There may be some common elements that may be reused for these features, and in addition, a unique requirement for each feature may exist. Given that a NBA-UWB system may operate in a populated multi-user scenario, it is important to support coexistence/interference for both NB and UWB. The matters related to the NB wireless technology may include duty-cycle optimization, channelization, frequency hopping, blocked channel list agreement and listen-before-talk (LBT) techniques. Ranging session definition and a PHY level parameter also need to be specified. A MAC service may provide an open interface to deliver schedules, initial timing and frequency synchronization and deliver configuration information obtained from an assistance NB to a UWB operation. The MAC may be defined to provide a clear and generic baseline for various use cases. Since each application may have a different requirement, it may be desirable to focus on common elements between specific applications, instead of trying to find a resolution suitable for all cases.

A PHY may include an additional and/or refined technology to enable NBA-UWB-based features defined in MAC. In particular, details for the O-QPSK (offset-quadrature phase shift keying) of the IEEE 802.15.4 series standard, UWB, etc. may include some modifications and refinements to the PHY aspect of NBA-UWB. Alternatively, PHYS different from O-QPSK may also assist UWB by utilizing an open interface provided by a MAC service.

Since O-QPSK supports good link budget and efficient implementation, it may provide a very good baseline for the NB aspect of UWB. A 250 kbps mode (or a 250 k mode) may be applied as a main element in the relatively optimized airtime. Exemplary refinements for O-QPSK are as follows.
In addition to a 2450 MHz band defined in the existing IEEE 802.15.4 standard, a new band such as Unlicensed National Information Infrastructure (UNII)-3, UNII-5, etc. may be used.
Channelization for this band may enable reduced airtime for frequency-hopping and other services. It may reduce a preamble length and increase a data rate.
A requirement for clock accuracy may be defined.
Convolutional channel coding using a predefined generator polynomial may be applied, and low-density parity-check code (LDPC) coding may also be optionally applied.

For clock accuracy, an additional NB mode may be arranged with UWB. The carrier frequency and chipping rate frequency of HRP UWB must be derived from the same reference oscillator, and must have accuracy within +20 ppm to −20 ppm or better. In order to utilize the features of NBA-UWB, a similar optional mode for O-QPSK may be defined.

As an O-QPSK-based PPDU format, PPDU configuration (config)-1, PPDU configuration-2, or PPDU configuration-3 may be applied. As described by referring to FIGS. 2 and 3, a PPDU may basically include a preamble, a SFD, a PHR and a payload. PPDU configuration-1 may provide a baseline for a data rate of 250 kbps, and other PPDU configurations may be optionally defined for optimized tradeoff between airtime and a link budget. In addition, 1 chip may have a duration of 0.5 us and 1 symbol may carry 4 bits (e.g., when forward error correction (FEC) is applied, 4 bits may correspond to coded bits). Meanwhile, the number of chips within 1 symbol may be referred to as a spreading factor (SF).

For example, for a 10-byte-sized PSDU payload, a data rate according to a PPDU configuration and the length of each field are as follows.
PPDU Configuration-1: Data Rate=250 kbps, Preamble Length=128 us, SFD Length=32 us, PHR Length=32 us, Payload Length=320 us, Entire Packet Duration=512 us
PPDU Configuration-2: Data Rate=500 kbps, Preamble Length=64 us, SFD Length=32 us, PHR Length=28 us, Payload Length=172 us, Entire Packet Duration=296 us (A rate-1/2 convolution code is applied to both a PHR and a payload, a PHR carries 28 (=(8+6)*2) coded bits, and a payload carries 172 (=(80+6)*2) coded bits.)
PPDU Configuration-3: Data Rate=1000 kbps, Preamble Length=64 us, SFD Length=32 us, PHR Length=28 us, Payload Length=80 us, Entire Packet Duration=204 us

Both out-of-band (OOB) signaling and in-band signaling may be used to indicate a NB configuration. For OOB signaling, a SFD may have a format as in a table below.

TABLE 8

| Bit: 0 | 1 | 2 | 3 | 4 | 5 | 6 | 7 |
|---|---|---|---|---|---|---|---|
| 1 | 1 | 1 | 0 | 0 | 1 | 0 | 1 |

For in-band signaling, SFDs may be used to indicate different NB configurations as in a table below.

TABLE 9

| SFD | NB Configuration #, Data Rate |
|---|---|
| 1 1 1 0 0 1 0 1 | #1, 250 kbps |
| 1 0 0 0 1 0 1 0 | #2, 500 kbps |
| 0 1 0 0 1 0 0 1 | #3, 1000 kbps |
| 0 0 1 0 1 0 1 1 | #4, 250 kbps |
| 1 0 1 0 0 0 0 1 | #5, 1000 kbps |

The starting point of a NBA-UWB PHY may be a UWB PHY. For example, a no-data packet format for refining a link budget has already been defined. MMS UWB may include the extension of a no-data packet for further refining a link budget and ToF accuracy. In a corresponding packet format, a short fragment having at least a millisecond of start-to-start spacing may exist, and the entire packet may have a length across a plurality of fragments. 1 millisecond may correspond to 499200 chips.

A MMS UWB packet may include a plurality of fragments divided into two types: a ranging sequence fragment (RSF) and a ranging integrity fragment (RIF).

First, a RSF is described.
Each RSF may include repetition of a selected MMS ranging sequence (MMRS). One common MMRS may be used in all RSFs.
16 complementary sets-based MMRS sequences of length-128 may be defined. Each element of a sequence may be indicated as + or −. Code indexes 33, 34, . . . , 48 may be allocated to each of the 16 MMRS sequences. Each MMRS sequence may be separated into two parts [A, B]. A and B may have a length of 64, respectively. Gap G consisting of 0 to 64 zero values may be added to configure a MMRS having a gap such as [A, G, B, G].
As a MMRS, ternary codes of length-91 and length-127 (e.g., a code defined in the IEEE 802.15.4z standard) may be optionally applied. The use of these ternary codes may cause more interference to a neighboring legacy device compared to the above-described length-128 MMRS.
Spreading factor L=4 may be applied to a MMRS with or without a gap before repetition within one RSF.

Next, a RIF is described.
Each RIF may carry the waveform of pulses modulated in a pseudo-random way for ranging integrity. An existing STS may be applied as a baseline for this waveform.
A RIF may include one STS segment to which spreading factor L=4 is applied. Each STS segment may have the same length.
The polarity of all STS pulses in all RIFs within one MMS UWB packet may be generated by using a deterministic random bit generator (DRBG) based on AES-128 in a counter mode.

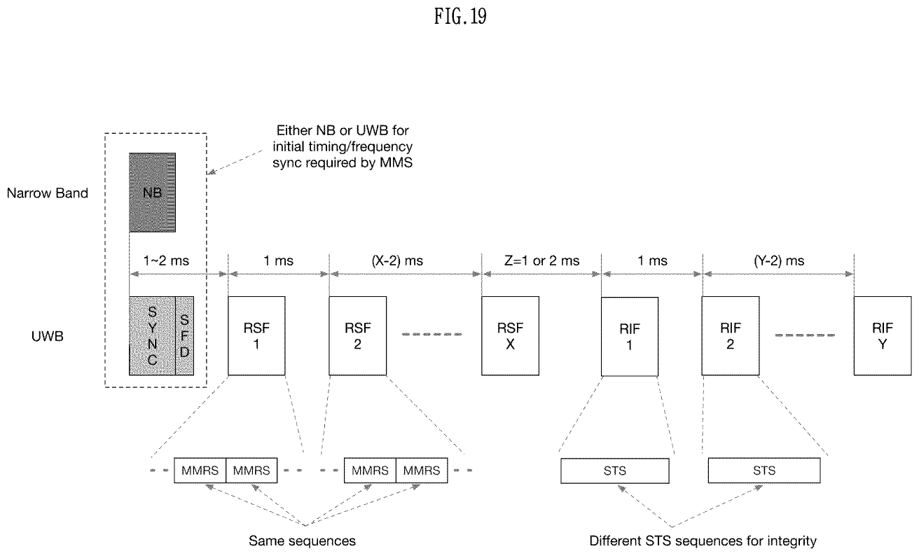

FIG. 19 is a diagram representing an example of a MMS packet to which the present disclosure may be applied.

An example in FIG. 19 represents an example of a generic MMS packet to which NB assistance is or is not applied. An allowable configuration for X, Y and Z indicated in FIG. 19 is described in detail below.

In each RSF, a MMRS symbol is generated first, and then a corresponding MMRS symbol may be repeated N_MSR times. One MMRS symbol may be generated as follows.

When a MMRS is used based on a complementary set, MMRS symbol S′=[A′, G′, B′, G′] may be obtained by determining a MMRS that does not include a gap in step-1, i.e., [A, B] (here, A and B are a sequence of length-64, respectively); obtaining a MMRS that determines gap G and includes a gap in step-2, i.e., S=[A, G, B, G]; and applying spreading using spreading factor L=4 in step-3.

When an Ipatov sequence is used for a MMRS, MMRS symbol S′ may be obtained by determining Ipatov sequence S in step-1; and applying spreading using spreading factor L=4 in step-2.

N_MSR, the number of MMRS repetitions within each RSF, may be configured as one value of the set {32, 40, 48, 64, 128, 256}. A small value of N_MSR may be advantageous for coexistence due to short active transmission, and a large value of N_MSR may be advantageous for the entire energe use even without a high-performance power amplifier (PA). The value of N_MSR may be the same in all RSFs within one MMS packet.

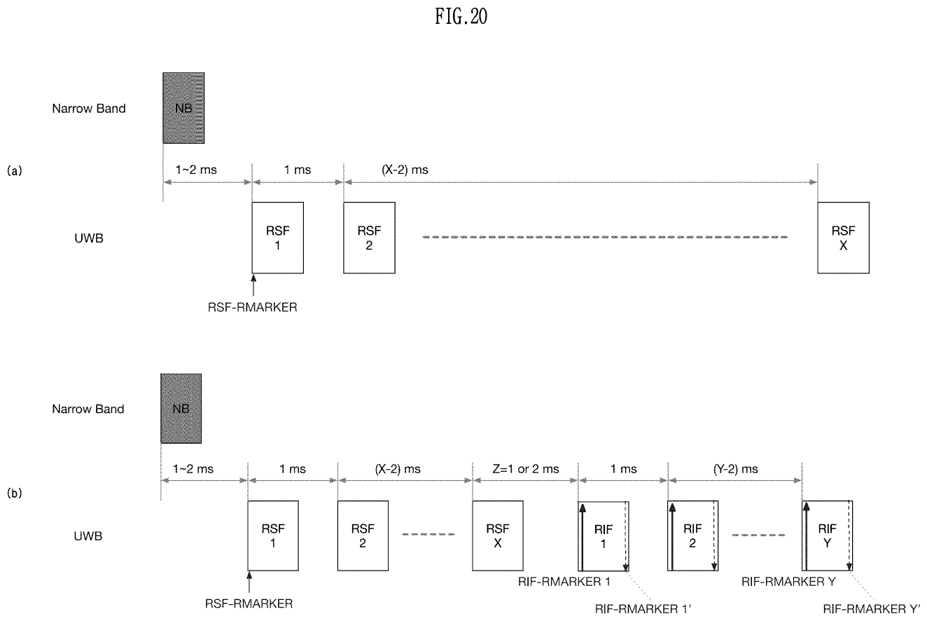

FIG. 20 is a diagram representing additional examples of a MMS packet to which the present disclosure may be applied.

A RSF-only MMS packet format in FIG. 20(a) may enable efficient and rapid channel impulse response (CIR) generation by using MMS coherent combining. In a mixed MMS packet format for ranging integrity in FIG. 20(b), RIFs may follow RSFs.

For a RSF-only MMS packet in FIG. 20(a), the following numerology may be applied to increase processing gain.

X, the number of preamble fragments, may be configured as one value of the set {1, 2, 4, 8, 16}. RSF-RMARKER may be defined as the peak of the first pulse of the first RSF.

In a mixed MMS packet for ranging integrity in FIG. 20(b), when a NB is used to assist timing/frequency synchronization, the following numerology may be applied.

Additional RIF-RMARKERs may be defined as the peak of the first pulse and the peak of the last pulse of each RSF. RIF-RMARKER y corresponds to the peak of the first pulse of RIF-y, and RIF-RMARKER y′ corresponds to the peak of the last pulse of RIF-y. In order to increase the gain, X, the number of RFSs, may be configured as one value of the set {0, 1, 2, 4, 8}, and Y, the number of RIFs, may be configured as one value of the set {1, 2, 4, 8}. X=0 may imply a RIF-only MMS packet.

For example, the first mode with X=Y=1, 2, 4, 8 and the second mode with X=1 and Y=2, 4, 8 may be defined as a baseline. In addition, other combinations of X and Y values may be optionally applied.

In case of Z-2, an additional Ims gap between RSFs and RIFs may provide an additional time budget before starting to process fragments for integrity verification.

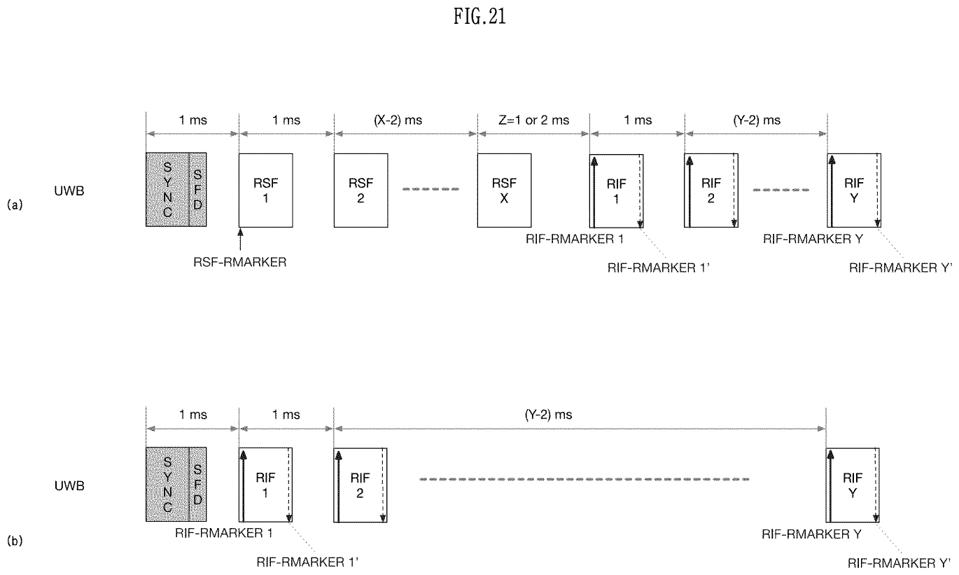

FIG. 21 is a diagram representing additional examples of a MMS packet to which the present disclosure may be applied.

FIG. 21(a) represents an example of a UWB-only mixed MMS packet including RSFs in case of X>0, and FIG. 21(b) represents an example of a UWB-only mixed MMS packet including only RIFs in case of X=0 and Y>0.

When a NB is not used to report timing/frequency synchronization, the following numerology may be applied to a mixed MMS packet for ranging integrity.

As in the examples of FIG. 21, SYNC and SFD may be included in a MMS packet.

Additional RIF-RMARKERs may be defined as the peak of the first pulse and the peak of the last pulse of each RIF.

X may be configured as one value of the set {0, 1, 2, 4, 8}, and Y may be configured as one value of the set {0, 1, 2, 4, 8}. Here, Y=0 may be allowed when ranging integrity is not provided. X-0 and Y=1 may be defined as a default configuration for facilitating interoperability. In case of X>0, an additional Ims gap between RSFs and RIFs in case of Z=2 may provide an additional time budget before starting to process fragments for integrity verification.

The refinement methods for better interference detection and ranging performance for a NBA-UWB technique and techniques that use only UWB wireless technologies to achieve link budget refinement compared to the existing MMS ranging may be further applied.

### UWB Sensing

The terms used in UWB sensing are defined as follows.

A sensing initiator may correspond to a sensing device that initiates a RF sensing session with at least one other UWB device.

A sensing responder may correspond to a sensing device that responds to a sensing initiator.

A sensing transmitter may correspond to a sensing device that transmits a channel sounding PPDU to enable channel estimation for RF sensing.

A sensing recipient may correspond to a sensing device that receives a channel sounding PPDU from a sensing transmitter to perform channel estimation.

A sensing request device may correspond to a sensing device that requests a sensing CIR measurement report from a proxy application.

A sensing device (SDEV) is a device possesses a sensing capability, and may conditionally support a mandatory basic feature set that enables high-performance UWB sensing.

An operating mode for UWB sensing is described below.

In a basic sensing mode, in most RF sensing scenarios, a sensing initiator corresponds to a device where a RF sensing application exists, and accordingly, a sensing initiator may request a measured CIR. When a sensing initiator corresponds to a sensing transmitter, an over-the-air (OTA) CIR measurement report may be transmitted by a sensing responder to provide a CIR to a sensing initiator. In addition, in a proxy application, a device requesting a proxy operation may receive an OTA CIR measurement report from a sensing initiator. A scenario possible based on the role of sensing devices may include mono-static sensing, bi-static sensing (when an initiator corresponds to a sensing recipient), bi-static sensing (when an initiator corresponds to a sensing transmitter), multi-static sensing (when an initiator corresponds to a sensing recipient), multi-static sensing (when an initiator corresponds to a sensing transmitter and supports the scheduling of an OTA CIR measurement report from a plurality of responders) and proxy (including a basic proxy mode and a hierarchical proxy mode).

In a collaborative sensing mode, mono-static and multi-static sensing nodes may exchange sensing results. It may enable an application such as collaborative localization or authentication in an environment based on distributed sensing devices.

In a simultaneous sensing and ranging mode, in a ranging application, the position of an UWB device may be identified by searching a timestamp corresponding to the shortest path in a CIR. In a sensing application, a CIR may also be used to extract target information including range, velocity and angle. Since information on both the shortest path and a reflected path is included in a CIR, it is possible to perform ranging and sensing simultaneously based on a CIR. Simultaneous ranging and sensing may be supported by modifying relevant information elements (IEs) for the existing ranging protocols. For a non-sensing-oriented application, a method for switching a pulse shape for different applications such as a unified pulse shape for a simultaneous sensing and ranging mode may also be considered.

A sensing procedure is described below.

A sensing procedure may define a sensing frame exchange sequence. A frame exchange sequence for each sensing mode may exist. A sensing block, a round and a slot may be defined by generalizing an existing ranging sequence. By using this structure, different sensing phases such as a sensing session setup phase, a sensing measurement phase, a measurement report phase, etc. may be specified in a sensing block. A packet transmission sequence may also be considered for frequency stitching across a carrier frequency spaced apart by an integer multiple of 124.8 MHz.

During the sensing session setup, a sensing procedure may define a capability exchange phase for bi-static, multi-static and proxy scenarios. The list of parameters to be negotiated may include a device role, a measurement report format, a measurement method included in a measurement report, a calculated feature, etc. For this purpose, at least one dedicated IE format for sensing may be additionally defined.

A sensing measurement report may be defined in two types. A MLME sensing measurement report may be used to transmit a sensing measurement result to the application layer of an initiator device. It may be transmitted from a MAC layer within a device to higher layers through MLME. According to the role of a sensing device, an OTA sensing measurement report transmitted from a responder to an initiator may be required.

Both a MLME sensing measurement report and an OTA sensing measurement report may include a sensing measurement result. Three sensing measurement result formats (i.e., a window-based CIR measurement report, a compressed CIR measurement report, and a processed target feature report) may be considered for a sensing measurement result.

A window-based CIR measurement report may include the CIR of a specific window. This type may be primarily used for bi-static and multi-static sensing applications.

For example, a window-based CIR may be measured from a received sensing PPDU packet. In this case, a window-based method for a CIR sensing report may be used to provide the consistency of multiple CIR measurement reports across packets.

In a window-based CIR report, a CIR measurement report may include two parts.

The first part may include a sensing control parameter (e.g., the number of antennas, a CIR window duration (W_length), a CIR window offset (W_offset), a latency calibration result for each RF chain and a phase). This sensing control parameter may or may not be included in a CIR measurement report according to whether an initiator requests it.

The second part may include the content field of a CIR measurement report (e.g., CIR in-phase and quadrature values for each chain, a normalization factor for each chain, etc.). A window may have a reference point specified as the earliest detected tap or the strongest detected tap of a CIR. When it is assumed that a reference point corresponds to time t0, a window may start at time t0+W_offset and end at time t0+W_offset+W_length. Each tap may correspond to a sensing PPDU packet received with strength equal to or greater than/greater than a noise threshold. In addition, a CIR sampling rate for a CIR measurement report may be determined.

For sensing modes where a sensing initiator is a sensing transmitter, a CIR report may be transmitted by OTA, and may be additionally transmitted to the higher layer of an initiator for processing.

Next, a compressed CIR measurement report may include a compressed CIR. This type may be used for bi-static, multi-static and proxy sensing applications.

For some sensing modes, an OTA sensing measurement report may be transmitted to transmit a sensing measurement result. In order to reduce the feedback overhead of multiple CIR measurement reports and reduce airtime, CIR compression may be required before transmission. To solve the large dynamic range issue of CIR measurement, CIR compression may be required to balance quantization accuracy and signaling overhead.

Finally, a processed target report may include processed channel information such as range, velocity, angle of arrival (AOA), etc. for target(s) of interest. It may be used for mono-static, external time and frequency synchronization-based multi-static or bi-static sensing.

For mono-static sensing where inherent synchronization is available, and for bi-static and multi-static sensing where external synchronization is used, a processed target feature report may be specified. A processed target feature report may include two parts. The first part may include a sensing control parameter (e.g., including fields such as the number of targets of a sensing task and the number of antennas). The second part may include a content field (e.g., including sensing features such as the range and velocity of target(s) and the AoA of target(s)). The definition and calculation method of each processed metric (measurement value) of a content field may be defined.

The examples of a sensing result format described above may be selected according to a sensing application, a sensing mode, the capability of a sensing node, etc. It may be negotiated through a sensing capability exchange during a sensing session setup phase.

A privacy problem may be considered in determining a sensing protocol, and for example, an encryption method for CIR report encryption, a physical layer secure method, etc. may be applied. In addition, the new or modified feature of PHY and MAC for the coexistence of sensing, ranging and communication applications may be defined.

For a PHY feature related to sensing, as a RF requirement, a sensing pulse shape may be designed to ensure that parameters in a reflected path are accurately measured. For example, as a criterion for evaluating whether a sensing pulse shape is good, in addition to widely used criteria such as a time-domain mask and a power spectral density (PSD) mask, other metrics such as range resolution, peak to sidelobe ratio (PSLR), spectral efficiency (or root mean square (RMS) bandwidth) and zero-Doppler ambiguity function may be introduced to evaluate the performance of a sensing pulse shape. In addition, a sensing pulse shape may be designed to avoid both pre-ringing and post-ringing. A more restrictive time-domain mask may be specified for a sensing pulse shape compared to ranging. A pulse shape may be designed to support both sensing and ranging.

Support for sensing through an additional sensing packet structure configuration may be defined by considering various existing combinations used as sensing alone as well as used with an additional sensing field. A sensing function may be combined with communication and ranging. This combined packet structure may be designed to meet an appropriate requirement in terms of performance and complexity for each function.

A pulse pattern and sequence for sensing may be defined. For example, a pulse pattern may be defined differently for mono-static and bi-static/multi-static. Bi-static/multi-static may be defined to reuse the pulse pattern of ranging. For mono-static sensing, a pulse burst sensing technique may be considered. A sequence for sensing may also be defined by being considered along with non-secure ranging and preamble.

### Sensing Control and Sensing Performance

As described above, defining a new MAC control method is required to support sensing control and sensing performance for UWB sensing. For example, an efficient and unified MAC structure compatible with a MAC control structure for the existing ranging may be defined through a minimal or optimal change in a MAC control structure defined in the existing UWB ranging. However, the examples of the present disclosure are not limited and applied to a unified MAC control method for ranging and sensing, and may also be applied as a MAC control method for sensing (only).

The examples of the role of devices for the existing ranging and a message exchanged between a controller and a controlee or between an initiator and a responder are the same as described by referring to FIG. 11 described above. In addition, the format of an ARC IE is the same as described by referring to FIG. 12(a) described above, and in particular, multi-node ranging may be supported as shown in Table 2. Next, the format of a RDM IE is the same as described by referring to FIG. 12(b) described above.

Since the existing MAC control structure where this message exchange including an ARC IE, a RDM IE, etc. is defined supports a ranging procedure, but does not support a sensing procedure, a new/modified MAC control structure suitable for a sensing procedure needs to be defined. In addition, since a RCM is used to define parameters necessary for a ranging procedure (e.g., the type of ranging, a device's ranging role, etc.), but does not define a parameter related to a sensing procedure, new/modified parameters suitable for a sensing procedure need to be defined.

For example, among the fields within the existing ARC IE, information that may be commonly used in ranging and sensing and information that requires a change may be summarized as follows.

TABLE 10

| Field | Whether to reuse for a sensing procedure |
|---|---|
| Multi-node | Reusable, A multi-node mode may use the same structure |
| mode | in ranging and sensing. |
| Ranging round | Non-reusable, OWR, SS-TWR, DS-TWR and ranging |
| usage | ancillary information exchanges are defined for this field, |
| | which considers only ranging and thus, needs to be |
| | redefined for sensing. |
| STS packet | Reusable, A STS packet configuration may use the same |
| configuration | structure in ranging and sensing. |
| Schedule mode | Reusable, A schedule mode may be used in the same way |
| | in ranging and sensing. |
| Deferred mode | Reusable, A deferred mode may be used in the same way |
| | in ranging and sensing. |
| Time structure | Reusable, A time structure indicator may be used in the |
| indicator | same way in ranging and sensing. |
| RCM validity | Reusable, The RCM validity rounds may be used in the |
| rounds | same way in ranging and sensing. |
| MMRCR | Reusable, A MMRCR may be used in the same way in |
| (multiple | ranging and sensing. |
| message | |
| receipt | |
| confirmation | |
| request) | |
| Content control | Reusable, Content control may be used in the same way |
| | in ranging and sensing. |

For example, among the fields within the existing RDM IE, information that may be commonly used in ranging and sensing and information that requires a change may be summarized as follows.

TABLE 11

| Field | Whether to reuse for a sensing procedure |
|---|---|
| SIU (slot | Reusable, SIU may be used in the same way |
| index usage) | in ranging and sensing. |
| Address size | |
| RDM list length | Non-reusable, A RDM list element includes |
| RDM list | a ranging role, a ranging slot index and |
| element(s) | an address field, but needs not only to |
| | define a sensing initiator/responder but |
| | also to define a sensing transmitter/recipient |
| | in order to define a sensing mode. |

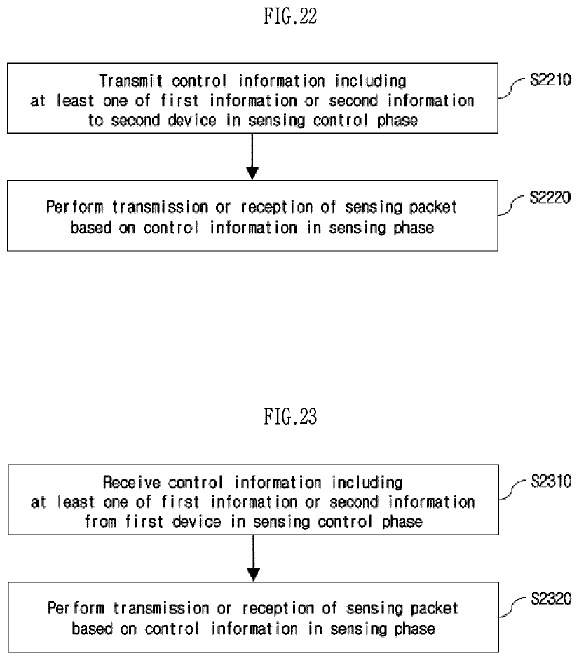

In this way, a pre-defined MAC control structure for ranging may be reused for a sensing procedure. For example, it may be assumed that a block, a round and a slot structure for ranging are reused for sensing. In this case, since an ARC IE used in a step of configuring a parameter through a RCM indicates only a part for ranging round usage and ranging scenario (or ranging mode), it is necessary to define a new field or a new IE to additionally indicate a sensing scenario (or a sensing mode). In addition, since only a ranging role is defined in the RDM list element of a RDM IE, it is necessary to define a new field or a new IE to indicate the role of a sensing transmitter/a sensing recipient. To this end, a new method for exchanging control information for a sensing procedure and a new method for performing an operation for transmitting and receiving a sensing packet based on sensing control information are described below. FIG. 22 is a diagram for describing the operation of the first device according to the present disclosure.

In the example of FIGS. 22 and 23, the first device may correspond to a sensing initiator or a controller, and the second device may correspond to a sensing responder or a controlee.

In S2210, the first device may transmit control information including at least one of the first information or the second information to the second device in a sensing control phase.

The first information may indicate the sensing role of the second device. A sensing role may correspond to a sensing transmitter or a sensing recipient. A sensing transmitter may transmit a sensing packet in a sensing phase. A sensing recipient may receive a sensing packet in a sensing phase. For example, the first information may be defined as 1 bit-sized information/field.

The first information may additionally indicate the sensing role of the first device. For example, the first information may be defined as a 2 bit-sized information/field, which may indicate the sensing role of the first device and the sensing role of the second device.

The second information may indicate a sensing mode in a sensing phase. A sensing mode may correspond to sensing by mono-static, bi-static, multi-static or proxy, and the second information may indicate one of them. For example, the second information may be defined as 2 bit-sized information/field.

Control information including this first information and/or second information may be included in one IE. Alternatively, control information including the first information and/or the second information may be included in a plurality of IEs. For example, the first information may be included in the first IE, and the second information may be included in the second IE.

In S2220, the first device may transmit or receive a sensing packet based on control information in a sensing phase.

For example, when the first information of the control information indicates that the second device is a sensing recipient, the first device may transmit a sensing packet and the second device may receive a sensing packet in a sensing phase. For example, when the first information of the control information indicates that the second device is a sensing transmitter, the second device may transmit a sensing packet and the first device may receive a sensing packet in a sensing phase.

A sensing phase may be performed after a sensing control phase. If a sensing measurement report phase exists, a sensing measurement report phase may be performed after a sensing phase.

For example, in any one of a plurality of sensing rounds (or each of a plurality of rounds) within a sensing block, the first sensing slot (e.g., sensing slot index 0) may be used for a sensing control phase. In any one of a plurality of corresponding sensing rounds (or each of a plurality of rounds) within a corresponding sensing block, the first at least one slot (or sensing slot index 1, . . . , M) after the first sensing slot (or sensing slot index 0) corresponding to a sensing control phase may be used for a sensing phase. If a sensing measurement report phase exists, the second at least one slot (or sensing slot index M+1, . . . , N−1) after the first at least one slot (or sensing slot index 1, . . . , M) used for a sensing phase may be used for a sensing measurement report phase.

A sensing packet may have the format of a PPDU including SHR, PHR and PHY payload fields as shown in the example of FIG. 2 described above. A PHY payload field (or a PSDU) may include MHR, MAC payload and MFR fields. For example, the above-described control information may be included in a MAC payload field. A PSDU including this control information may be generated as a PPDU according to an O-QPSK PHY method.

A method described in the example of FIG. 22 may be performed by a first device 100 in FIG. 1. For example, at least one processor 102 of the first device 100 in FIG. 1 may be configured to transmit control information including at least one of the first information or the second information to the second device through at least one transceiver in a sensing control phase (e.g., the first information may indicate the sensing role of the second device and the second information may indicate a sensing mode in a sensing phase) and to perform the transmission or reception of a sensing packet through at least one transceiver based on control information in a sensing phase. Furthermore, at least one memory 104 of a first device 100 may store instructions for performing a method described in the example of FIG. 22 or examples described below when executed by at least one processor 102.

As a specific example, a method in FIG. 22 may be performed by a transmitting device or a controller. A transmitting device (or a controller) may generate a PSDU including the above-described control information. This PSDU may be generated by including information on sensing round usage, information on a sensing role and/or information on sensing packet transmission/reception according to a sensing procedure. A generated PSDU may be transmitted to a PHY layer to generate a PPDU including a SHR and a PHR. Accordingly, a transmitting device (or a controller) may perform modulation and/or spreading on the binary data of a generated PPDU and generate a modulated signal to transmit it to a receiving device (or a controlee) through an antenna.

FIG. 23 is a diagram for describing the operation of the second device according to the present disclosure.

In S2310, the second device may receive control information including at least one of the first information or the second information from the first device in a sensing control phase.

In S2320, the second device may transmit or receive a sensing packet based on control information in a sensing phase.

Since specific descriptions for the first information, the second information, control information including the first information and/or the second information and an operation in a sensing phase based on control information are the same as described by referring to FIG. 22, an overlapping description is omitted.

A method described in the example of FIG. 23 may be performed by the second device 200 of FIG. 1. For example, at least one processor 202 of the first device 200 in FIG. 1 may be configured to receive control information including at least one of the first information or the second information from the first device through at least one transceiver in a sensing control phase (e.g., the first information may indicate the sensing role of the second device and the second information may indicate a sensing mode in a sensing phase) and to perform the transmission or reception of a sensing packet through at least one transceiver based on control information in a sensing phase. A message/a packet received through a transceiver 206 may be stored in a memory 204. A processor 202 may perform decoding on a message/a packet stored in a memory 204. A processor 202 may obtain control information included in a message/a packet and store obtained control information in a memory 204. A processor 202 may remove noise and interference through amplification and filtering and convert a signal into binary data through sampling, demodulation and decoding processes. For example, in a decoding process, a BPSK or O-QPSK demodulator may be used, and a process of mapping a chip to a symbol, convolution, Reed-Solomon decoding, etc. may be performed. The reconstructed data may be used to extract original information transmitted by a transmitting end. This process may include various error correction and data recovery techniques to check if transmitted data is correctly received. In addition, a processor 202 may decode the data field of a packet received through a transceiver 206. In addition, a processor 202 may process decoded data. For example, a processor 202 may transmit information on a decoded data field to a higher layer (e.g., a MAC layer) and, when the generation of a signal is indicated from a higher layer to a PHY layer in response thereto, perform a subsequent operation. Furthermore, at least one memory 204 of a second device 200 may store instructions for performing a method described in the example of FIG. 23 or examples described below when executed by at least one processor 202.

As a specific example, a method in FIG. 23 may be performed by a receiving device or a controlee. A receiving device (or a controlee) may obtain a PSDU including the above-described control information from a received PPDU. For example, a receiving device (or a controlee) may perform demodulation, decoding, etc. on a received PPDU to convert a signal into a binary bit. A PPDU converted into a binary bit may be transmitted to a MAC layer to extract a PSDU. Information on sensing round usage, information on a sensing role and/or information on sensing packet transmission/reception may be obtained from this PSDU according to a sensing procedure.

The examples of FIGS. 22 and 23 may correspond to some of the various examples of the present disclosure. Hereinafter, various examples of the present disclosure including the example of FIGS. 22 and 23 will be described in more detail.

### Embodiment 1

This embodiment relates to a control operation for a sensing mode and a sensing role.

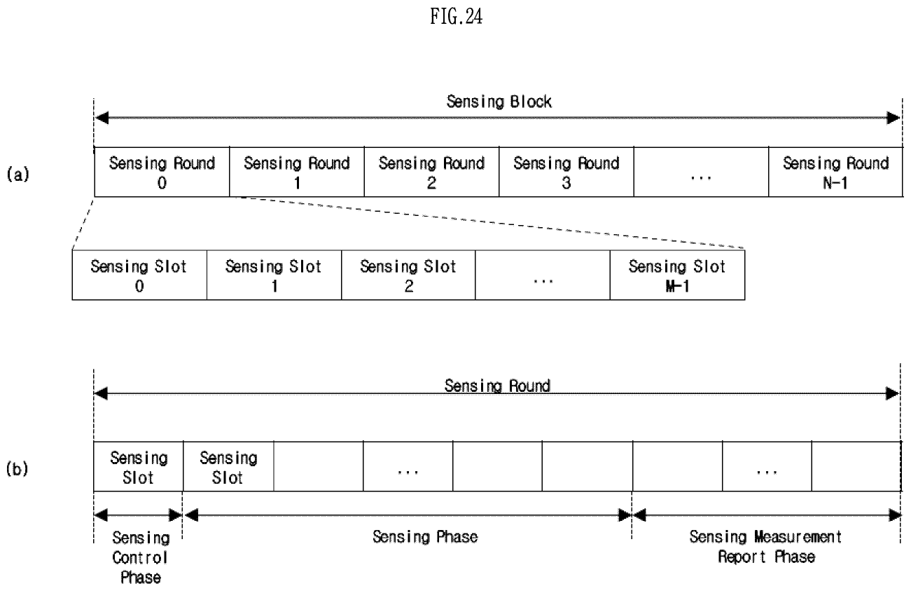

FIG. 24 is a diagram for describing a sensing block structure and a sensing phase according to the present disclosure.

The structures of a sensing block, a sensing round and a sensing slot in an UWB sensing session as shown in the example of FIG. 24 may be defined similarly to the structures of a ranging block, a ranging round and a ranging slot as shown in the example of FIG. 13. In other words, considering backward compatibility with an existing ranging operation, a ranging block structure may be reused rather than additionally defining a block structure for a sensing operation. In addition, when one sensing round includes N sensing slots, a sensing control phase may be performed in the first sensing slot (i.e., sensing slot index 0), a sensing phase may be performed in subsequent M (M is an integer equal to or greater than 1) slots (i.e., sensing slot index 1, . . . , M), and a sensing measurement report phase may be performed in subsequent N-M slots (i.e., sensing slot index M+1, . . . , N−1). A sensing measurement report phase may or may not exist.

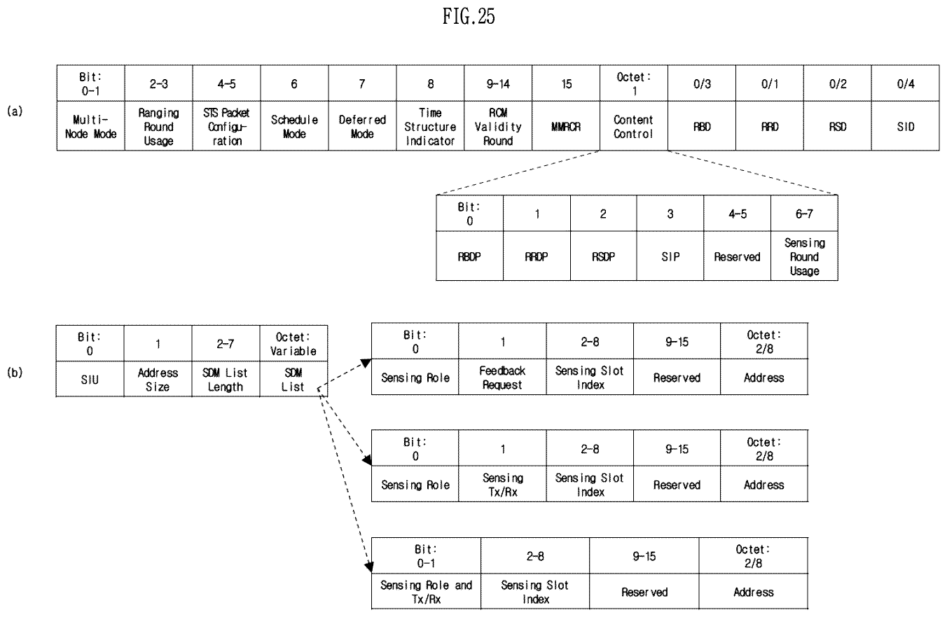

FIG. 25 represents an example of an information element (IE) including sensing-related control information according to the present disclosure.

An IE as shown in FIG. 25(a) may correspond to a modified ARC IE or an IE with a different name, and an IE as shown in FIG. 25(b) may correspond to a sensing device management (SDM) IE or an IE with a different name. The names of exemplary IEs in FIG. 25 are merely for reference, and the scope of the present disclosure is not limited by the names or number of IEs.

In addition, it is described in the example in FIG. 25 that fields indicating sensing-related control information (e.g., information on a sensing mode and information on a sensing role) are included in a plurality of IEs, but corresponding fields may also be included in one IE. In other words, IEs as shown in the example of FIG. 25 are merely an example for describing a corresponding relationship or a difference with an ARC IE (FIG. 12(a)) and a RDM IE (FIG. 12(b)) related to an existing ranging procedure, and the remaining fields excluding sensing-related control information/fields described in the present disclosure are not essential, so all examples in which corresponding fields are included in one IE or is included in a plurality of IEs are included in the scope of the present disclosure. In addition, a part of the sensing-related control information/fields described in the present disclosure may be included in one IE or may be included in a plurality of IEs, or all of the corresponding fields may be included in one IE or may be included in a plurality of IEs.

A sensing round usage field may be included in the modified ARC IE of FIG. 25(a). Here, the scope of the present disclosure is not limited by a field name of ‘sensing round usage’, and a field with a different name indicating a sensing mode is also included in the scope of the present disclosure. A sensing round usage field may correspond to a ranging round usage field in an ARC IE related to ranging.

A sensing round usage field may indicate a sensing mode. A sensing mode may correspond to sensing by mono-static, bi-static, multi-static or proxy. A sensing round usage field may be defined as a size of 2 bits or more. Accordingly, a sensing round usage field may indicate one of multiple sensing modes. For example, the first value (or 0) of a sensing round usage field may indicate mono-static, the second value (or 1) may indicate bi-static, the third value (or 2) may indicate multi-static, and the fourth value may be reserved. Alternatively, the first value (or 0) of a sensing round usage field may indicate mono-static, the second value (or 1) may indicate bi-static, the third value (or 2) may indicate multi-static, and the fourth value may indicate sensing by proxy.

If a modified ARC IE includes an existing ranging round usage field as it is, there is no reserved bit value which will indicate sensing round usage in a ranging round usage field, so a sensing round usage field may be defined as being included in another field. For example, since bits 4-7 of a content control field within an existing ARC IE((FIG. 12(a)) are defined as being reserved, a part/all of the corresponding 4 bits may be defined as a sensing round usage field. The example of FIG. 25(a) represents that a sensing round usage field is defined as a 2-bit size of bits 6-7. If a new IE including a sensing round usage field is defined, a sensing round usage field of 2 bits or more may be defined at an arbitrary position (e.g., within a sensing control field).

Among the sensing modes, bi-static and multi-static sensing may be classified into a detailed sensing scenario according to a sensing role. For example, for a bi-static sensing mode, it may include a case in which a responder is a sensing recipient (or a case in which an initiator is a sensing transmitter) and a case in which a responder is a sensing transmitter (or a case in which an initiator is a sensing recipient). Similarly, for a multi-static sensing mode, it may include a case in which a responder is a sensing recipient (or a case in which an initiator is a sensing transmitter) and a case in which a responder is a sensing transmitter (or a case in which an initiator is a sensing recipient). In order to clearly indicate this sensing scenario, information on a sensing role may be defined/provided as sensing-related control information.

For example, information on a sensing role may be included in the SDM IE of FIG. 25(b). A SDM IE may correspond to a new IE corresponding to a RDM IE related to the existing ranging procedure or may correspond to the modified version of a RDM IE. Here, the scope of the present disclosure is not limited by a field name of ‘sensing role’, and a field with a different name indicating the role of a responder, the role of an initiator or the roles of an initiator and a responder is also included in the scope of the present disclosure. A sensing role field may correspond to a ranging role field in a RDM IE related to ranging.

A sensing role field may be defined as a 1-bit size. Accordingly, when the value of a sensing role field is the first value (or 0), it may indicate that a responder is the transmitter of a sensing packet (or an initiator is the recipient of a sensing packet), and when it is the second value (or 1), it may indicate that a responder is the recipient of a sensing packet (or an initiator is the transmitter of a sensing packet).

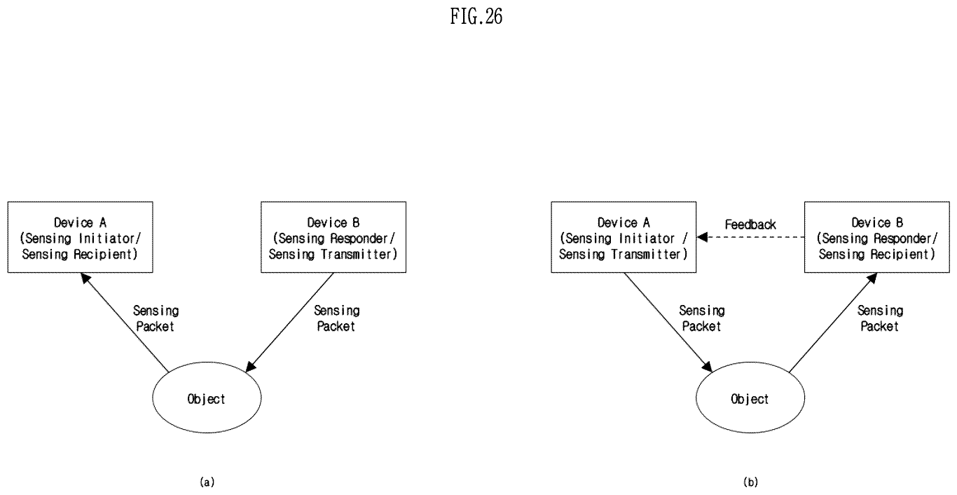

FIG. 26 is a diagram representing an example of active sensing and passive sensing according to the present disclosure.

In the examples of FIG. 26, a sensing packet may be transmitted by a sensing transmitter, reflected by an object and received by a sensing recipient. As in the example of FIG. 26(a), when an initiator is a sensing transmitter and a responder is a sensing recipient, it may correspond to active sensing. As in the example of FIG. 26(b), when an initiator is a sensing recipient and a responder is a sensing transmitter, it may correspond to passive sensing. In active sensing, an initiator may perform sensing on an object from a sensing packet that an initiator receives. In passive sensing, a responder may perform sensing on an object from a sensing packet that a responder receives and transmit a result thereof as feedback (e.g., CIR feedback) to an initiator. Feedback may also be performed when requested by an initiator.

A 1 bit-sized sensing role field described above may be combined with an additional 1-bit field to indicate a sensing scenario.

For example, an additional 1-bit field which may be combined with a 1-bit sensing role field may indicate whether feedback is requested. Whether feedback is requested may indicate whether CIR feedback (from a responder to an initiator) is required or not. Alternatively, when CIR feedback is required, it may correspond to the above-described active sensing, and when CIR feedback is not required, it may correspond to the above-described passive sensing.

According to the combination of a 1-bit sensing role field and a 1-bit feedback request field, a sensing transmitter or recipient role (i.e., a sensing scenario) may be indicated for both an initiator and a responder as follows, respectively.

TABLE 12

| | Feedback request field = 0 | Feedback request field = 1 |
|---|---|---|
| | (Passive sensing) | (Active sensing) |
| Sensing | Sensing responder = Sensing | Sensing responder = Sensing |
| role | transmitter | recipient (transmit CIR |
| field = 0 | | feedback to a sensing |
| | | initiator) |
| Sensing | Sensing initiator = Sensing | Sensing initiator = Sensing |
| role | recipient | transmitter (receive CIR |
| field = 1 | | feedback from a sensing |
| | | responder) |

Additionally or alternatively, an additional 1-bit field which may be combined with a 1-bit sensing role field may indicate sensing transmission/reception.

According to the combination of a 1-bit sensing role field and a 1-bit sensing transmission/reception field, a sensing transmitter or recipient role (i.e., a sensing scenario) may be indicated for both an initiator and a responder as follows, respectively.

TABLE 13

| | Sensing | Sensing |
|---|---|---|
| | transmission/reception | transmission/reception |
| | field = 0 | field = 1 |
| | (Sensing recipient) | (Sensing transmitter) |
| Sensing | Sensing responder = Sensing | Sensing responder = Sensing |
| role | recipient (transmit CIR | transmitter |
| field = 0 | feedback to a sensing | |
| | initiator) | |
| Sensing | Sensing initiator = Sensing | Sensing initiator = Sensing |
| role | recipient | transmitter (receive CIR |
| field = 1 | | feedback from a sensing |
| | | responder) |

Additionally or alternatively, a sensing transmitter or recipient role (i.e., a sensing scenario) may be indicated for both an initiator and a responder through 2 bits corresponding to a sensing role field and an additional field, respectively. When the value of the first bit among the two bits is the first value (or 0), it may correspond to a sensing responder, and when it is the second value (or 1), it may correspond to a sensing initiator. When the value of the second bit among the two bits is the first value (or 0), it may correspond to a sensing recipient, and when it is the second value (or 1), it may correspond to a sensing transmitter. Through these 2 bits, a sensing transmitter or recipient role (e.g., a sensing scenario) may be indicated for both an initiator and a responder as follows, respectively.

TABLE 14

| Value of sensing | |
|---|---|
| role and | |
| transmission/reception | |
| fields | Meaning |
| 0 (0b00) | Sensing responder = Sensing recipient (transmit |
| | CIR feedback to a sensing initiator) |
| 1 (0b01) | Sensing responder = Sensing transmitter |
| 2 (0b10) | Sensing initiator = Sensing recipient |
| 3 (0b11) | Sensing initiator = Sensing transmitter |
| | (Receive CIR feedback from a sensing responder) |

Embodiment 2 This embodiment relates to an operation for transmitting and receiving sensing-related control information and a sensing operation based on sensing-related control information.

In an initial configuration message sequence for ranging as in the example of FIGS. 17 and 18 described above, an initiator/a controller may include an ARC IE and a RDM IE in a RCM and transmit them to a responder/a controlee to configure a ranging parameter. In order to apply sensing-related control information/parameter while maintaining compatibility with a ranging control structure, a RCM (or a sensing control message (SCM)) including the above-described modified ARC IE and/or SDM IE (or one new IE or a plurality of new IEs) may be transmitted from an initiator/a controller to a responder/a controlee.

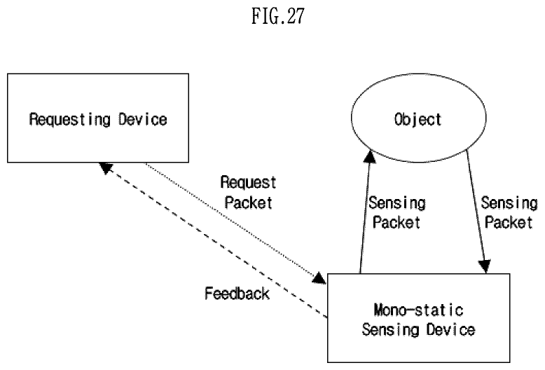

FIG. 27 is a diagram for describing an example of the operation of devices in a mono-static sensing mode according to the present disclosure.

For example, a requesting device may request sensing from a mono-static sensing device through a proxy application. A RCM (or a SCM) corresponding to a request packet for requesting sensing may include at least one IE (e.g., a modified ARC IE and/or SDM IE, or one IE) including the above-described sensing-related control information (e.g., information on a sensing mode and/or information on a sensing role).

Here, the value of a sensing round usage field may be set as the first value (or 0) indicating a mono-static sensing mode.

In a mono-static sensing mode, a single device may act as both a sensing transmitter and a sensing recipient. Accordingly, since there is no need to designate a sensing role, information/a field for a sensing role may not exist in an IE (e.g., a SDM IE) included in a RCM (or a SCM).

In the example of FIG. 27, the requesting device of a proxy application may transmit a request packet to a mono-static sensing device to request sensing, and a sensing device may perform sensing by transmitting and receiving a sensing packet. In addition, a requesting device may receive feedback (e.g., a CIR report) on a sensing result from a sensing device.

Referring again to FIG. 26(a), an example of the operation of devices in a bi-static sensing mode where an initiator is a sensing recipient is described. A RCM (or a SCM) transmitted from an initiator/a controller to a responder/a controlee may include at least one IE (e.g., a modified ARC IE and/or SDM IE, or one IE) including the above-described sensing-related control information (e.g., information on a sensing mode and/or information on a sensing role).

Here, the value of a sensing round usage field may be set as the second value (or 1) indicating a bi-static sensing mode.

The value of a 1-bit sensing role field may be set as the second value (or 1) indicating that a responder is the recipient of a sensing packet.

Additionally or alternatively, a sensing scenario may be indicated as follows through a 1-bit sensing role field and a 1-bit additional field.

When an additional field is a feedback request field, referring again to Table 12, for an initiator (or device A), a sensing role field may be set as the second value (or 1) and a feedback request field may be set as the first value (or 0), and for a responder (or device B), a sensing role field may be set as the first value (or 0) and a feedback request field may be set as the first value (or 0).

When an additional field is a sensing transmission/reception field, referring again to Table 13, for an initiator (or device A), a sensing role field may be set as the second value (or 1) and a sensing transmission/reception field may be set as the first value (or 0), and for a responder (or device B), a sensing role field may be set as the first value (or 0) and a sensing transmission/reception field may be set as the second value (or 1).

For 2-bit sensing role and transmission/reception fields, referring again to Table 14, for an initiator (or device A), sensing role and transmission/reception fields may be set as the third value (or 2 or 0b10), and for a responder (or device B), sensing role and transmission/reception fields may be set as the second value (or 1 or 0b01).

Referring again to FIG. 26(b), an example of the operation of devices in a bi-static sensing mode where an initiator is a sensing transmitter is described. A RCM (or a SCM) transmitted from an initiator/a controller to a responder/a controlee may include at least one IE (e.g., a modified ARC IE and/or SDM IE, or one IE) including the above-described sensing-related control information (e.g., information on a sensing mode and/or information on a sensing role).

Here, the value of a sensing round usage field may be set as the second value (or 1) indicating a bi-static sensing mode.

The value of a 1-bit sensing role field may be set as the first value (or 0) indicating that a responder is the transmitter of a sensing packet.

Additionally or alternatively, a sensing scenario may be indicated as follows through a 1-bit sensing role field and a 1-bit additional field.

When an additional field is a feedback request field, referring again to Table 12, for an initiator (or device A), a sensing role field may be set as the second value (or 1) and a feedback request field may be set as the second value (or 1), and for a responder (or device B), a sensing role field may be set as the first value (or 0) and a feedback request field may be set as the second value (or 1).

When an additional field is a sensing transmission/reception field, referring again to Table 13, for an initiator (or device A), a sensing role field may be set as the second value (or 1) and a sensing transmission/reception field may be set as the second value (or 1), and for a responder (or device B), a sensing role field may be set as the first value (or 0) and a sensing transmission/reception field may be set as the first value (or 0).

For 2-bit sensing role and transmission/reception fields, referring again to Table 14, for an initiator (or device A), sensing role and transmission/reception fields may be set as the fourth value (or 3 or 0b11), and for a responder (or device B), sensing role and transmission/reception fields may be set as the first value (or 0 or 0b00).

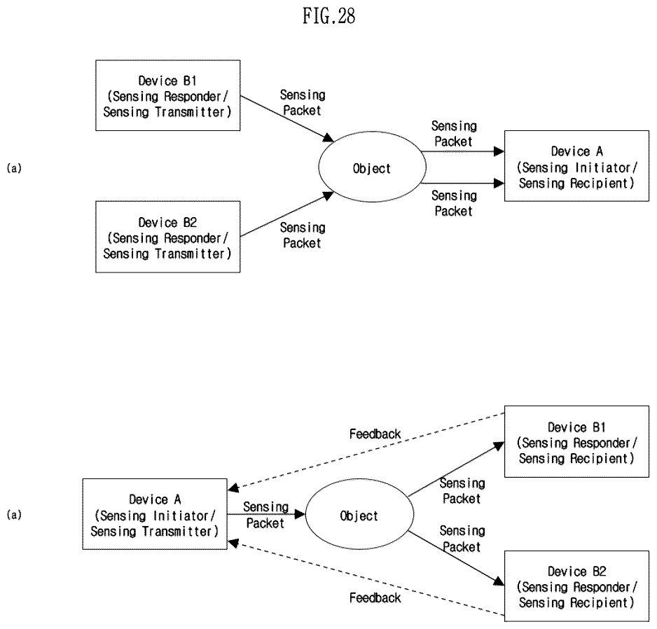

FIG. 28 is a diagram for describing examples of the operation of devices in a multi-static sensing mode according to the present disclosure.

FIG. 28(a) represents an example for a case in which an initiator corresponds to a sensing recipient and a plurality of responders correspond to a sensing transmitter. A RCM (or a SCM) transmitted from an initiator/a controller to a responder/a controlee may include at least one IE (e.g., a modified ARC IE and/or SDM IE, or one IE) including the above-described sensing-related control information (e.g., information on a sensing mode and/or information on a sensing role).

Here, the value of a sensing round usage field may be set as the third value (or 2) indicating a multi-static sensing mode.

The value of a 1-bit sensing role field may be set as the first value (or 0) indicating that each of the responders (device B1 and device B2) is the transmitter of a sensing packet.

Additionally or alternatively, a sensing scenario may be indicated as follows through a 1-bit sensing role field and a 1-bit additional field.

When an additional field is a feedback request field, referring again to Table 12, for an initiator (or device A), a sensing role field may be set as the second value (or 1) and a feedback request field may be set as the first value (or 0), and for the first responder (or device B1), a sensing role field may be set as the first value (or 0) and a feedback request field may be set as the first value (or 0), and for the second responder (or device B2), a sensing role field may be set as the first value (or 0) and a feedback request field may be set as the first value (or 0).

When an additional field is a sensing transmission/reception field, referring again to Table 13, for an initiator (or device A), a sensing role field may be set as the second value (or 1) and a sensing transmission/reception field may be set as the first value (or 0), and for the first responder (or device B1), a sensing role field may be set as the first value (or 0) and a sensing transmission/reception field may be set as the second value (or 1), and for the second responder (or device B2), a sensing role field may be set as the first value (or 0) and a sensing transmission/reception field may be set as the second value (or 1).

For 2-bit sensing role and transmission/reception fields, referring again to Table 14, for an initiator (or device A), sensing role and transmission/reception fields may be set as the third value (or 2 or 0b10), and for the first responder (or device B1), sensing role and transmission/reception fields may be set as the second value (or 1 or 0b01), and for the second responder (or device B2), sensing role and transmission/reception fields may be set as the second value (or 1 or 0b01).

FIG. 28(b) represents an example for a case in which an initiator corresponds to a sensing transmitter and a plurality of responders correspond to a sensing recipient. A RCM (or a SCM) transmitted from an initiator/a controller to a responder/a controlee may include at least one IE (e.g., a modified ARC IE and/or SDM IE, or one IE) including the above-described sensing-related control information (e.g., information on a sensing mode and/or information on a sensing role).

Here, the value of a sensing round usage field may be set as the third value (or 2) indicating a multi-static sensing mode.

The value of a 1-bit sensing role field may be set as the first value (or 0) indicating that each of the responders (device B1 and device B2) is the transmitter of a sensing packet.

Additionally or alternatively, a sensing scenario may be indicated as follows through a 1-bit sensing role field and a 1-bit additional field.

When an additional field is a feedback request field, referring again to Table 12, for an initiator (or device A), a sensing role field may be set as the second value (or 1) and a feedback request field may be set as the second value (or 1), and for the first responder (or device B1), a sensing role field may be set as the first value (or 0) and a feedback request field may be set as the second value (or 1), and for the second responder (or device B2), a sensing role field may be set as the first value (or 0) and a feedback request field may be set as the second value (or 1).

When an additional field is a sensing transmission/reception field, referring again to Table 13, for an initiator (or device A), a sensing role field may be set as the second value (or 1) and a sensing transmission/reception field may be set as the second value (or 1), and for the first responder (or device B1), a sensing role field may be set as the first value (or 0) and a sensing transmission/reception field may be set as the first value (or 0), and for the second responder (or device B2), a sensing role field may be set as the first value (or 0) and a sensing transmission/reception field may be set as the first value (or 0).

For 2-bit sensing role and transmission/reception fields, referring again to Table 14, for an initiator (or device A), sensing role and transmission/reception fields may be set as the fourth value (or 3 or 0b11), and for the first responder (or device B1), sensing role and transmission/reception fields may be set as the first value (or 0 or 0b00), and for the second responder (or device B2), sensing role and transmission/reception fields may be set as the first value (or 0 or 0b00).

According to various examples of the present disclosure, the sensing mode of a sensing session and/or the role of devices participating in a sensing session may be clearly and efficiently indicated.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

A method proposed in the present disclosure is described based on an example applied to an IEEE 802.15.4-based system, but it may be applied to various UWB wireless network or wireless communication systems other than an IEEE 802.15.4-based system.

1. A method comprising:
transmitting, by a first device to a second device, control information including at least one of first information or second information in a sensing control phase, wherein the first information indicates a sensing role of the second device, and the second information indicates a sensing mode in a sensing phase; and
in the sensing phase, performing, by the first device, a transmission or a reception of a sensing packet based on the control information.

2. The method of claim 1, wherein:
the sensing role corresponds to a sensing transmitter or a sensing recipient.

3. The method of claim 2, wherein:
the sensing transmitter transmits the sensing packet in the sensing phase, and
the sensing recipient receives the sensing packet in the sensing phase.

4. The method of claim 1, wherein:
the first information is 1-bit information.

5. The method of claim 1, wherein:
the first information further indicates a sensing role of the first device.

6. The method of claim 1, wherein:
the first information is 2-bit information, and
the first information indicates a sensing role of the first device and the sensing role of the second device.

7. The method of claim 1, wherein:
the second information indicates one of sensings by a mono-static, a bi-static, a multi-static, or a proxy.

8. The method of claim 1, wherein:
the second information is 2-bit information.

9. The method of claim 1, wherein:
the control information is included in one information element (IE).

10. The method of claim 1, wherein:
the control information is included in a plurality of IEs.

11. The method of claim 1, wherein:
in each of at least one of a plurality of sensing rounds within a sensing block, a first sensing slot is used for the sensing control phase, and
in the each of the at least one of the plurality of sensing rounds within the sensing block, a first at least one slot after the first sensing slot is used for the sensing phase.

12. The method of claim 11, wherein:
a second at least one slot after the first at least one slot used for the sensing phase is used for a sensing measurement report phase.

13. The method of claim 1, wherein:
the first device is a sensing initiator or a controller, and the second device is a sensing responder or a controlee.

14. A first device comprising:
at least one transceiver; and
at least one processor connected to the at least one transceiver,
wherein the at least one processor is configured to:
transmit, through the at least one transceiver, to a second device, control information including at least one of first information or second information in a sensing control phase, wherein the first information indicates a sensing role of the second device, and the second information indicates a sensing mode in a sensing phase; and
in the sensing phase, perform, through the at least one transceiver, a transmission or a reception of a sensing packet based on the control information.

15. (canceled)

16. A second device comprising:
at least one transceiver; and
at least one processor connected to the at least one transceiver,
wherein the at least one processor is configured to:
receive, through the at least one transceiver, from a first device, control information including at least one of first information or second information in a sensing control phase, wherein the first information indicates a sensing role of the second device, and the second information indicates a sensing mode in a sensing phase; and
in the sensing phase, perform, through the at least one transceiver, a transmission or a reception of a sensing packet based on the control information.

17. (canceled)

18. (canceled)
